(19) United States
(12) Patent Application Publication
(10) Pub. No.: US 2025/0171951 A1
(43) Pub. Date: May 29, 2025

(54) CLOTHES CARE APPARATUS AND METHOD FOR CONTROLLING THE SAME

(71) Applicant: Samsung Electronics Co., Ltd., Suwon-si (KR)

(72) Inventors: Chulwoo PARK, Suwon-si (KR); Sujin SEONG, Suwon-si (KR); Yeona HWANG, Suwon-si (KR); Youngchul KO, Suwon-si (KR); Myungju SHIN, Suwon-si (KR); Sanghoon LEE, Suwon-si (KR)

(21) Appl. No.: 18/920,350

(22) Filed: Oct. 18, 2024

Related U.S. Application Data
(63) Continuation of application No. PCT/KR2024/014837, filed on Sep. 30, 2024.

(30) Foreign Application Priority Data
Nov. 29, 2023 (KR) 10-2023-0170180

(51) Int. Cl. D06F 87/00; C02F 1/32; C02F 103/00; D06F 103/20; D06F 105/54

(52) U.S. Cl. CPC D06F 87/00; C02F 1/32; C02F 2103/002; C02F 2209/36; D06F 2103/20; D06F 2105/54

(57) ABSTRACT

A clothes care apparatus includes: a steam generation device comprising a steam generator; a water tank configured to supply water to the steam generation device, and recover the water discharged from the steam generation device; a microbial detection sensor configured to collect first sensor data related to an amount of microorganisms attached to the water tank; a water level sensor configured to collect second sensor data related to a water level of the water tank; a sterilization device configured to sterilize water stored in the water tank; and a controller comprising at least one processor, comprising processing circuitry, individually and/or collectively, configured to: control the sterilization device based on a first function related to the second sensor data, in response to a microbial contamination level determined based on the first sensor data being less than a reference contamination level, and control the sterilization device based on a second function related to the second sensor data, in response to the microbial contamination level being greater than or equal to the reference contamination level.

### CROSS-REFERENCE TO RELATED APPLICATIONS

This application is a continuation of International Application No. PCT/KR2024/014837 designating the United States, filed on Sep. 30, 2024, in the Korean Intellectual Property Receiving Office and claiming priority to Korean Patent Application No. 10-2023-0170180, filed on Nov. 29, 2023, in the Korean Intellectual Property Office, the disclosures of each of which are incorporated by reference herein in their entireties.

### BACKGROUND

### Field

The disclosure relates to a clothes care apparatus including a sterilization device for sterilizing water stored in a water tank and a method for controlling the same.

### Description of Related Art

A clothes care apparatus is a device that performs clothes care, such as drying wet clothes, removing dirt or odor from clothes, and reducing wrinkles in clothes.

The clothes care apparatus may include a heat exchanger for dehumidifying and heating air in a care room for drying clothes, and a steam generation device for performing refreshing functions such as removing wrinkles in clothes, deodorizing clothes, removing static electricity from clothes, providing fragrance, and the like.

The clothes care apparatus includes a water tank for storing water supplied to the steam generation device, and a drain tank for storing water discharged from the steam generation device or heat exchanger.

Users are required to periodically fill the water tank with water and empty the drain tank in order to use the clothes care apparatus.

### SUMMARY

Embodiments of the disclosure provide a clothes care apparatus wherein, a user is not required to fill a water tank and empty a drain tank, thereby improving user convenience.

Embodiments of the disclosure provide a clothes care apparatus wherein, an integrated water tank that functions as both a water tank and a drain tank may be provided, thereby improving ease of maintenance.

Embodiments of the disclosure provide a clothes care apparatus that may improve efficiency of a sterilization device.

Embodiments of the disclosure provide a clothes care apparatus and a method for controlling the same that may control an operation of a sterilization device based not only on water quality in a water tank but also on a microbial contamination level.

Embodiments of the disclosure provide a clothes care apparatus and a method for controlling the same that may request a user to clean a water tank, in a case where the water tank may not be completely cleaned by a sterilization device.

The effects that may achieved by the disclosure are not limited to the above-mentioned effects, and other effects not mentioned will be clearly understood by one of ordinary skill in the technical art to which the disclosure belongs from the following description.

According to an example embodiment of the disclosure, a clothes care apparatus may include: a steam generation device including a steam generator; a water tank configured to supply water to the steam generation device, and recover the water discharged from the steam generation device; a microbial detection sensor configured to collect first sensor data related to an amount of microorganisms attached to the water tank; a water level sensor configured to collect second sensor data related to a water level of the water tank; a sterilization device comprising circuitry configured to sterilize water stored in the water tank; and a controller including at least one processor, comprising processing circuitry, individually and/or collectively configured to: control the sterilization device based on a first function related to the second sensor data, in response to a microbial contamination level determined based on the first sensor data being less than a reference contamination level, and control the sterilization device based on a second function related to the second sensor data, in response to the microbial contamination level being greater than or equal to the reference contamination level, wherein the first function and the second function may be configured to determine an operation time of the sterilization device based on the second sensor data, and a maximum operation time of the sterilization device determinable by the first unction may be shorter than a minimum operation time of the sterilization device determinable by the second function.

According to an example embodiment of the disclosure, in a method for controlling a clothes care apparatus including a steam generation device comprising a steam generator, a water tank configured to supply water to the steam generation device and recover the water discharged from the steam generation device, and a sterilization device comprising circuitry configured to sterilize water stored in the water tank, the method may include: receiving first sensor data, related to an amount of microorganisms attached to the water tank, from a microbial detection sensor configured to collect the first sensor data; receiving second sensor data, related to a water level of the water tank, from a water level sensor configured to collect the second sensor data; controlling the sterilization device based on a first function related to the second sensor data, in response to a microbial contamination level determined based on the first sensor data being less than a reference contamination level; and controlling the sterilization device based on a second function related to the second sensor data, in response to the microbial contamination level being greater than or equal to the reference contamination level, wherein the first function and the second function may be configured to determine an operation time of the sterilization device based on the second sensor data, and a maximum operation time of the sterilization device determinable by the first unction may be shorter than a minimum operation time of the sterilization device determinable by the second function.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view illustrating an example clothes care apparatus according to various embodiments;

FIG. 2 is a perspective view illustrating an example clothes care apparatus with an open door according to various embodiments;

FIG. 3 is a side cross-sectional view of a clothes care apparatus according to various embodiments;

FIG. 4 is an exploded perspective view of a clothes care apparatus according to various embodiments;

FIG. 5 is a partial sectional perspective view illustrating a portion in which a steam ejector of a steam generation device of a clothes care apparatus is disposed according to various embodiments;

FIG. 6 is a diagram illustrating an enlarged view of a portion A of FIG. 3 according to various embodiments;

FIG. 7 is a perspective view of a steam generator of a steam generation device of a clothes care apparatus according to various embodiments;

FIG. 8 is a partial sectional perspective view of the steam generation device taken along line A-A′ of FIG. 7 according to various embodiments;

FIG. 9 is a cross-sectional view of a steam generator of a steam generation device of a clothes care apparatus according to various embodiments;

FIG. 10 is a cross-sectional view of a steam generator of a steam generation device of a clothes care apparatus according to various embodiments;

FIG. 11 are perspective views illustrating an example of an electrode sensor for detecting water level in a steam generation device of a clothes care apparatus according to various embodiments;

FIG. 12 is a perspective view illustrating a water tank of a clothes care apparatus according to various embodiments;

FIG. 13A and FIG. 13B are diagrams illustrating an example of a microbial detection sensor according to various embodiments;

FIG. 14 is a diagram illustrating an example of a steam generation system according to various embodiments;

FIG. 15 is a block diagram illustrating an example configuration of a clothes care apparatus according to various embodiments;

FIG. 16 is a flowchart illustrating an example method for controlling a clothes care apparatus according to various embodiments;

FIG. 17A and FIG. 17B illustrate example lookup tables related to a floating bacteria sterilization mode and an attached bacteria sterilization mode according to various embodiments;

FIG. 18 is a diagram illustrating an example interface provided by a clothes care apparatus, in a case where cleaning of a water tank is required according to various embodiments; and

FIG. 19 is a diagram illustrating an example interface provided by a clothes care apparatus, in a case where a user input to start a clothes care process is received in a state where cleaning of a water tank is required according to various embodiments.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like may be used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the disclosure, when an element is “on” another element, this includes not only when the element is in contact with the other element, but also when there is another element between the two elements.

The terms “front”, “rear”, “left”, “right”, “upper” and “lower” used in the following description are defined based on the drawings, and the shape and location of each component are not limited by these terms.

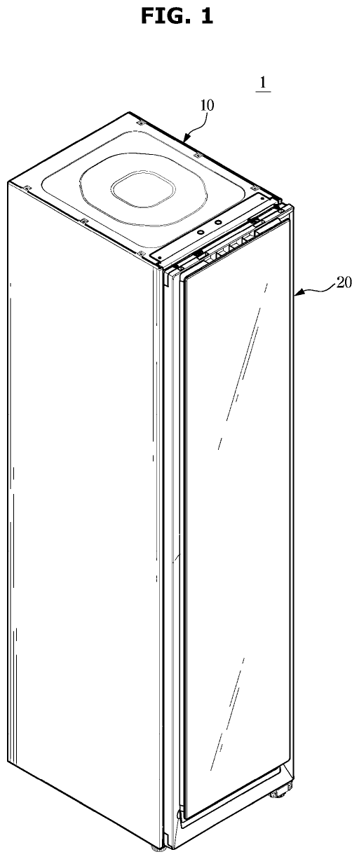

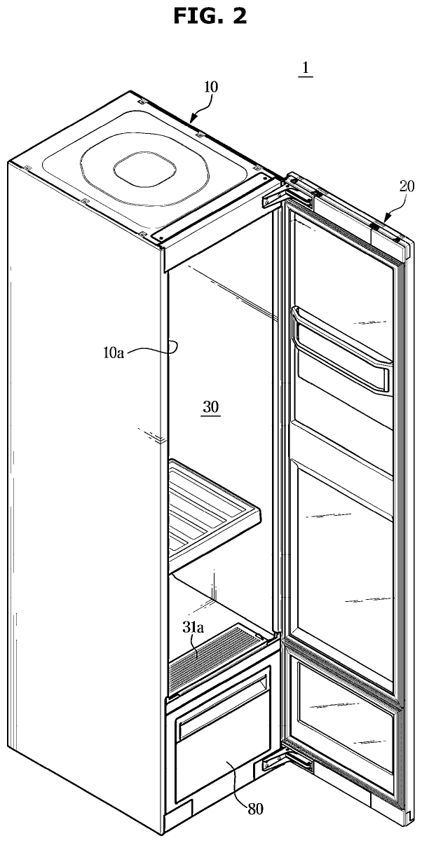

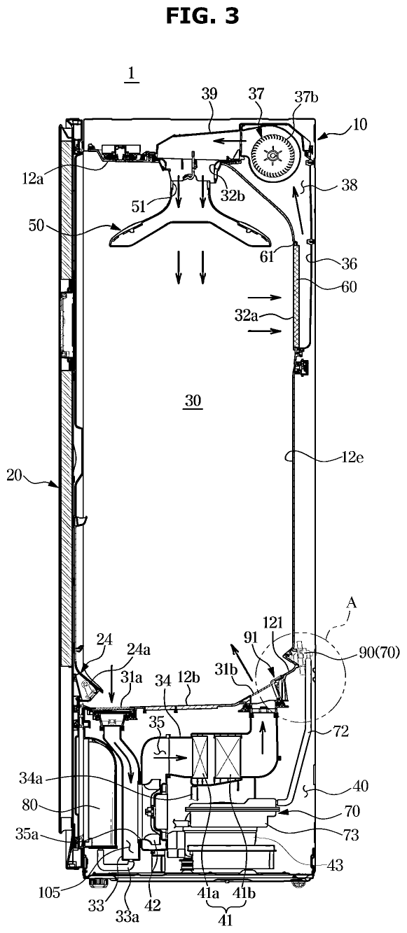

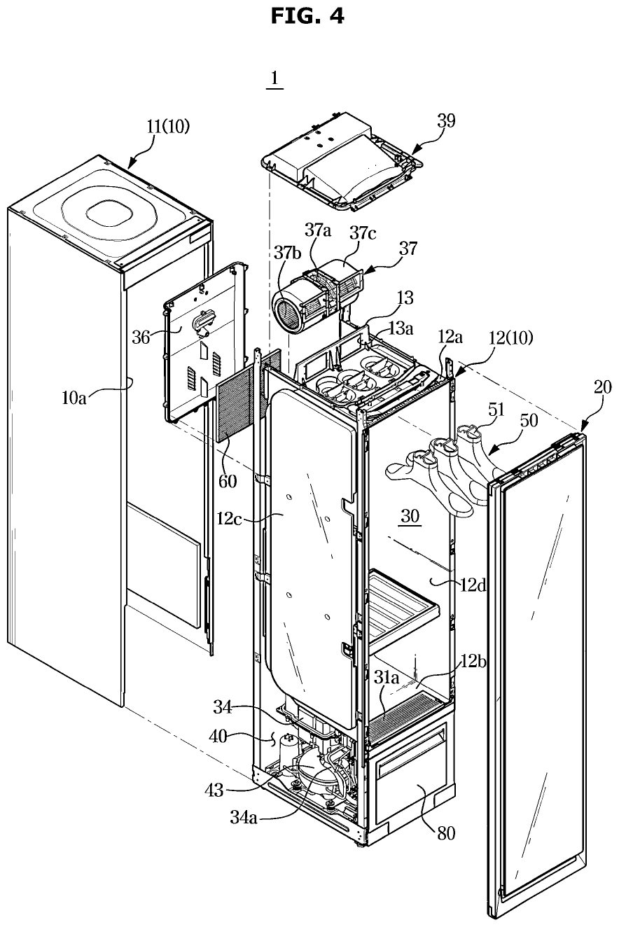

FIG. 1 is a perspective view illustrating an example clothes care apparatus according to various embodiments. FIG. 2 is a perspective view illustrating an example clothes care apparatus with an open door according to various embodiments. FIG. 3 is a side cross-sectional view of a clothes care apparatus according to various embodiments. FIG. 4 is an exploded perspective view of a clothes care apparatus according to various embodiments.

Referring to FIG. 1, FIG. 2, FIG. 3 and FIG. 4, a clothes care apparatus 1 may include a main body 10 forming an exterior, a door 20 rotatably coupled to the main body 10, a chamber 30 disposed in the main body 10 to accommodate clothes to be cared for, a garment support member 50 provided in the chamber 30 to hold a garment, and a machine room 40 provided with a heat exchanger 41 for dehumidifying or heating air in the chamber 30.

The main body 10 may have a hexahedral shape with one side open, and the chamber 30 may be formed in the main body 10. An opening 10a may be formed in a front side of the main body 10. The chamber 30 may be replaced by the term “garment care room” in that garments subject to be cared for are accommodated therein.

The door 20 is rotatably coupled to the main body 10 at the opening 10a to open and close the chamber 30. Although not shown, the door 20 may be installed via a connection member such as a hinge, link, or the like.

The main body 10 may include an outer cabinet 11 and an inner cabinet 12 disposed inside the outer cabinet 11.

The chamber 30 may form a space for accommodating garments. The chamber 30 may be formed with an upper side 12a, a lower side 12b, a left side 12c, a right side 12d, and a rear side 12e disposed on the inner cabinet 12. The front of the chamber 30 is formed to be open. Accordingly, an opening of the chamber 30 may be opened and closed together by the door 20 that opens and closes the opening 10a of the main body 10.

The chamber 30 may include a first airflow inlet 31a, a second airflow inlet 32a, a first airflow outlet 31b, and a second airflow outlet 32b.

The first airflow inlet 31a and the first airflow outlet 31b may be formed on the lower side 12b of the chamber 30. The first airflow inlet 31a may be disposed on a front portion of the lower side 12b of the chamber 30. The first airflow outlet 31b may be disposed at a rear portion of the lower side 12b of the chamber 30. The first airflow inlet 31a and the first airflow outlet 31b may be disposed close to each other.

The second airflow inlet 32a may be formed on an upper portion of the rear side 12e of the chamber 30. The second airflow outlet 32b may be formed at approximately the center of the upper side 12a of the chamber 30. The second airflow inlet 32a and the second airflow outlet 32b may be disposed close to each other.

At a lower portion of the main body 10, a water tank 80 may be detachably disposed from the main body 10. The water tank 80 may be disposed at a lower portion of the chamber 30, without being limited thereto. The water tank 80 detachable from the main body 10 may include the water tank 80 capable of being withdrawn from or inserted (mounted or docked) into a storage space formed in the main body 10.

In an embodiment, the water tank 80 may collect various condensates (condensed water) generated from the clothes care apparatus 1, and may supply water to a steam generation device 70. The various condensates generated from the clothes care apparatus 1 may include water discharged from the steam generation device 70.

The water tank 80 may recover the water discharged from the steam generation device 70, and supply the water back to the steam generation device 70. The water stored in the water tank 80 may be supplied to the steam generation device 70 and used to form steam.

In an embodiment, a partition may not be formed in the water tank 80, e.g., the water tank 80 may be provided as an integrated water supply/drainage type.

The water tank 80 may be detachable from the main body 10. A user may dispose of water stored in the water tank 80, refill the water tank 80, or the like, as needed.

The water tank 80 may be positioned in front of the machine room 40. The machine room 40 may be positioned in the lower portion of the main body 10. The water tank 80 may be replaced by terms such as “water reservoir” or “water storage portion” in that water is stored therein, and may also be replaced by terms such as “water supply and drainage reservoir”, “integrated water supply/drainage reservoir”, and the like, in that water supplied to the steam generation device 70 and various condensates generated by the clothes care apparatus 1 are stored therein.

The machine room 40 may be positioned below the chamber 30. The machine room 40 may include the heat exchanger 41 that may dehumidify and heat the air inside the chamber 30 as needed.

Inside the machine room 40, the heat exchanger 41, a first fan 42, a compressor 43, and the steam generation device 70 may be disposed.

The heat exchanger 41 may supply hot air into the chamber 30. The heat exchanger 41 may include an evaporator 41a and a condenser 41b through which refrigerant circulates to dehumidify and heat the air.

The refrigerant absorbs latent heat of surrounding air while evaporating in the evaporator 41a of the heat exchanger 41, thereby condensing and removing moisture in the air. When the refrigerant is condensed in the condenser 41b through the compressor 43, latent heat may be released to the surrounding air, thereby heating the surrounding air. For example, the evaporator 41a and the condenser 41b may function as a heat exchanger, and the air introduced into the machine room 40 by the first fan 42 may be dehumidified and heated while passing sequentially through the evaporator 41a and the condenser 41b.

The air introduced into the machine room 40 from the chamber 30 by the first fan 42 may be dehumidified while passing through the heat exchanger 41.

For example, the heat exchanger 41 may be configured to dehumidify and/or heat the air in the chamber 30. As the heat exchanger 41 dehumidifies and/or heats the air inside the chamber 30, condensate may be discharged from the heat exchanger 41. As will be described in greater detail below, the condensate discharged from the heat exchanger 41 may be stored in a sump 105.

Because the air in the chamber 30 is humidified by the steam sprayed from the steam generation device 70 and the heat exchanger 41 dehumidifies the air, the water discharged from the steam generation device 70 may include condensate discharged from the heat exchanger 41.

The sump 105 is a component for temporarily storing various condensates generated by the clothes care apparatus 1, and may include a container and/or structure for temporarily storing various condensates generated by the clothes care apparatus 1. For example, the sump 105 may include an interior space formed by a first duct 33, which will be described in greater detail below. As another example, the sump 105 may include an internal structure formed by the first duct 33.

The ducts 33 and 34 connecting the first airflow inlet 31a and the first airflow outlet 31b may be disposed in the machine room 40. For example, the ducts 33 and 34 may include the first duct 33 extending from the first airflow inlet 31a and the second duct 34 extending from the first airflow outlet 31b.

The first duct 33 may be connected to the first airflow inlet 31a of the chamber 30. The first duct 33 may be connected to the second duct 34. The second duct 34 may be connected to the first airflow outlet 31b.

One end of the first duct 33 may be connected to the first airflow inlet 31a of the chamber 30, and the other end of the first duct 33 may be connected to the second duct 34. One end of the second duct 34 may be connected to the first duct 33, and the other end of the second duct 34 may be connected to the first airflow outlet 31b of the chamber 30.

The second duct 34 may receive the evaporator 41a, the condenser 41b, and the first fan 42. The first duct 33 and the second duct 34 may be connected to the chamber 30, and form a first circulation flow path 35 that circulates between the chamber 30 and the first duct 33 and the second duct 34.

A communication port 35a through which the first duct 33 and the second duct 34 communicate with each other may be formed at a portion where the first duct 33 and the second duct 34 are connected. Air introduced into the first duct 33 by the first fan 42 may move to the second duct 34 through the communication port 35a.

Air in the chamber 30 may flow into the first circulation flow path 35 through the first airflow inlet 31a. The introduced air may be dehumidified and heated while passing through the heat exchanger 41, and the dehumidified and heated air may be discharged back to the chamber 30 through the first airflow outlet 31b.

In an embodiment of the disclosure, although it is illustrated as an example that the first airflow inlet 31a is disposed at the front of the chamber 30 and the first airflow outlet 31b is disposed at the rear of the chamber 30, the disclosure is not limited thereto. For example, the positions of the airflow inlet and airflow outlet may be varied as desired.

The first duct 33 may allow air introduced through the first airflow inlet 31a to be discharged to the first airflow outlet 31b. The air introduced through the first airflow inlet 31a may be dehumidified and/or heated by the heat exchanger 41 and discharged to the first airflow outlet 31b.

The first fan 42 may be positioned on the first circulation flow path 35 and may draw air from the chamber 30 into the first circulation flow path 35.

The clothes care apparatus 1 may further include the steam generation device 70 to generate steam by receiving water from the water tank 80 and spray the generated steam into the chamber 30. The steam generation device 70 may be disposed in the machine room 40. The steam generation device 70 may include a steam generator 73 connected to the water tank 80 to generate steam by receiving water from the water tank 80, a steam supply pipe 72 to guide the generated steam to a steam ejector 90, and the steam ejector 90 to spray the steam generated by the steam generator 73 into the chamber 30.

The steam ejector 90 may be disposed at a rear lower portion of the chamber 30.

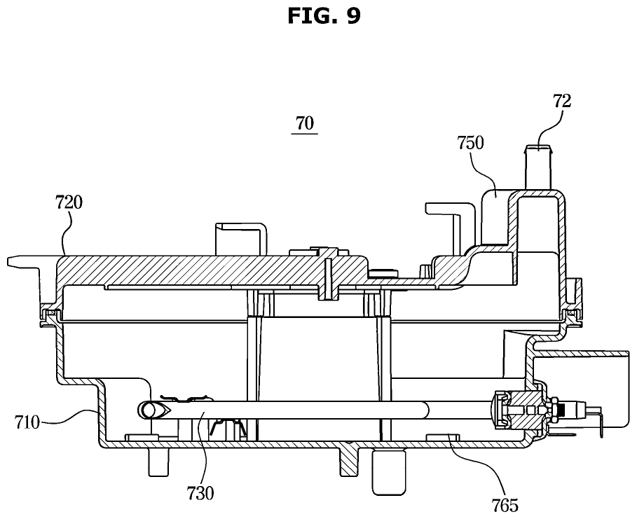

The steam generator 73 may include a space for storing water, e.g., water may be stored in the steam generator 73. In the disclosure, water in the steam generation device 70 may include water stored in the steam generator 73. The water stored in the steam generator 73 may include water stored in a case 710 (see FIG. 9). A heater 730 (see FIG. 9) for heating the water stored in the case 710 (see FIG. 9) may be installed in the case 710 (see FIG. 9) storing water.

The door 20 may include a door guide 24 for guiding movement of condensate. The door guide 24 may guide condensate that condenses and forms on a rear side of the door 20. The door guide 24 may include a curved portion 24a that is inclined downward from the rear side of the door 20 toward the chamber 30. Accordingly, the condensate formed on the rear side of the door 20 may descend under its own weight and move to the first airflow inlet 31a. The condensate moved to the first airflow inlet 31a may be stored in the sump 105. The condensate stored in the sump 105 may be moved to the water tank 80 through a first connection member 33a.

In an embodiment, the condensate discharged from the heat exchanger 41 and/or the condensate discharged from the steam generation device 70 may be stored in the sump 105.

A second connection member 34a may connect the second duct 34 and the first duct 33. The second connection member 34a may guide condensate in the second duct 34 to the first duct 33. The condensate guided to the first duct 33 may be stored in the sump 105. The condensate in the second duct 34 may include the water discharged from the steam generation device 70.

The water discharged from the steam generation device 70 may include condensate discharged from the heat exchanger 41 and/or condensate discharged from the steam ejector 90.

The first connection member 33a and/or the second connection member 34a may include a component capable of forming a flow path, such as a hose and/or pipe.

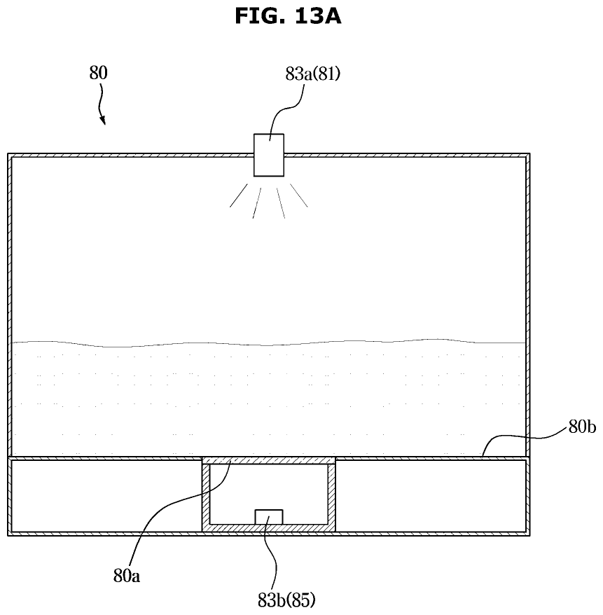

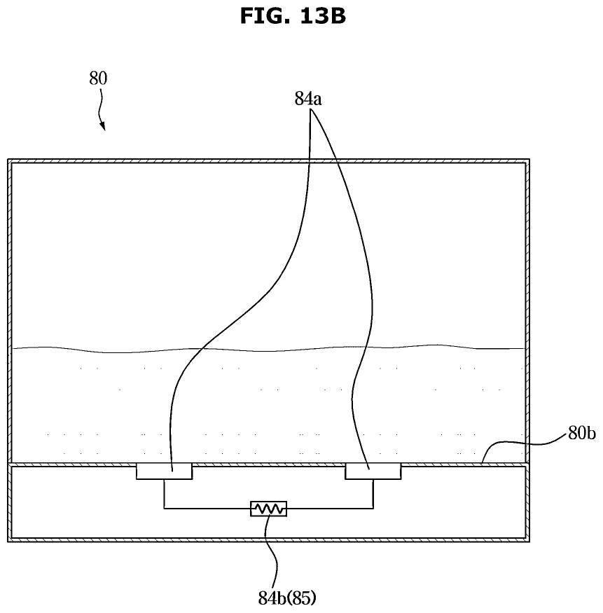

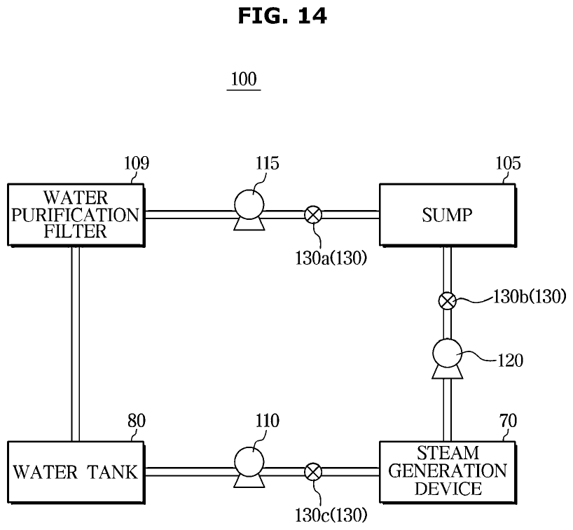

The condensate stored in the sump 105 may be moved to the water tank 80 through the first connection member 33a. As will be described in greater detail below, the clothes care apparatus 1 may include a sump pump 115 (see FIG. 13) to pump the condensate stored in the sump 105 to the water tank 80 through the first connection member 33a. Further, In an embodiment, the clothes care apparatus 1 may include a water purification filter 109 (see FIG. 14) disposed upstream of the water tank 80. Pumping the condensate stored in the sump 105 to the water tank 80 may include pumping the condensate stored in the sump 105 to the water purification filter 109.

The garment support member 50 in which a garment may be held and supported may be provided in the chamber 30. The garment support member 50 may be installed on the upper side 12a of the chamber 30. The garment support member 50 may be detachably installed in the chamber 30. At least one garment support member 50 may be provided. The garment support member 50 may be formed in the shape of a hanger for holding a garment.

The garment support member 50 may allow air to flow therein. Dirt or debris from the garment may be removed by air supplied into the garment support member 50. An air supply inlet 51 may be formed in the garment support member 50 to supply air to the garment.

The second airflow outlet 32b of the chamber 30 may communicate with the garment support member 50. Air discharged through the second airflow outlet 32b may be transferred to the garment support member 50 through the air supply inlet 51 and transferred to the inside of the garment held on the garment support member 50, or may be discharged outwardly of the air supply inlet 51 and transferred to the outside of the garment.

In an embodiment of the disclosure, although it is illustrated as an example that the second airflow outlet 32b is disposed above the garment support member 50, and air discharged through the second airflow outlet 32b is supplied to the inside and outside of the garment, the disclosure is not limited thereto. For example, the second airflow outlet may be formed in various sizes at various locations to spray air to the garment in various directions.

The clothes care apparatus 1 may include a second fan 37 for flowing internal air.

The clothes care apparatus 1 may include a third duct 36, and the second fan 37 may be installed in the third duct 36. The third duct 36 and the chamber 30 may communicate with each other, and thus the clothes care apparatus 1 may include a second circulation flow path 38 formed to allow air to circulate between the chamber 30 and the third duct 36. The second fan 37 may be disposed in the second circulation flow path 38.

The third duct 36 may be formed at the rear of the second airflow inlet 32a of the chamber 30. The third duct 36 may be positioned at the rear upper side of the chamber 30 and may include a filter member 60 therein. The third duct 36 may be coupled to a top cover 39 disposed at an upper portion of the chamber 30. The third duct 36 may be coupled to the top cover 39 and may have the second fan 37 installed therein.

The second fan 37 may be disposed at the rear upper portion of the chamber 30 and may include a blower motor 37a that generates a rotational force and at least one fan body 37b rotated by the blower motor. The fan body 37b may be accommodated by a fan case 37c.

The fan case 37c may be coupled to a duct bracket 13 positioned on the upper side 12a of the chamber 30. At least one duct hole 13a may be formed in the duct bracket 13, and the second fan 37 may be coupled to the at least one duct hole 13a to move air in the third duct 36 to the second airflow outlet 32b.

The third duct 36 may be connected to the second airflow inlet 32a of the chamber 30 and the top cover 39, and the top cover 39 may be connected to the third duct 36 and the second airflow outlet 32b.

One end of the third duct 36 may be connected to the second airflow inlet 32a of the chamber 30, and the other end thereof may be connected to the top cover 39. One end of the top cover 39 may be connected to the third duct 36, and the other end thereof may be connected to the second airflow outlet 32b.

The second airflow outlet 32b may communicate with the garment support member 50 to allow a portion of the air transferred from the third duct 36 to be transferred to the garment support member 50.

The second fan 37 disposed in the third duct 36 may allow air in the chamber 30 to be drawn in through the second airflow inlet 32a and be discharged to the second airflow outlet 32b.

The filter member 60 may be provided in the second airflow inlet 32a of the chamber 30. The second airflow inlet 32a may be formed at the rear side 12e of the chamber 30. A filter member installation portion 61 may be positioned on the rear side 12e of the chamber 30 to install the filter member 60. The second airflow inlet 32a may be formed at a position corresponding to the filter member installation portion 61.

In a case where the air in the chamber 30 flows into the third duct 36, the air may be filtered by the filter member 60 of the second airflow inlet 32a. The air flowing into the third duct 36 may be cleaned of dust and odor by the filter member 60. The air filtered by the filter member 60 may be discharged through the second fan 37 to the garment support member 50.

The filter member 60 may include a dust collecting filter (not shown) to remove dust or means for deodorizing.

A fragrance sheet 91 may be disposed in a portion of the inner cabinet 12 adjacent to the first airflow outlet 31b. The fragrance sheet 91 may be detachably coupled to the inner cabinet 12. Air discharged from the first airflow outlet 31b may provide a fragrance to a garment by the fragrance sheet 91.

To care for a garment, a user operates the clothes care apparatus 1 with the garment held on the garment support member 50 and the door 20 closed. In this instance, air in the chamber 30 may be circulated along the first circulation flow path 35 and the second circulation flow path 38.

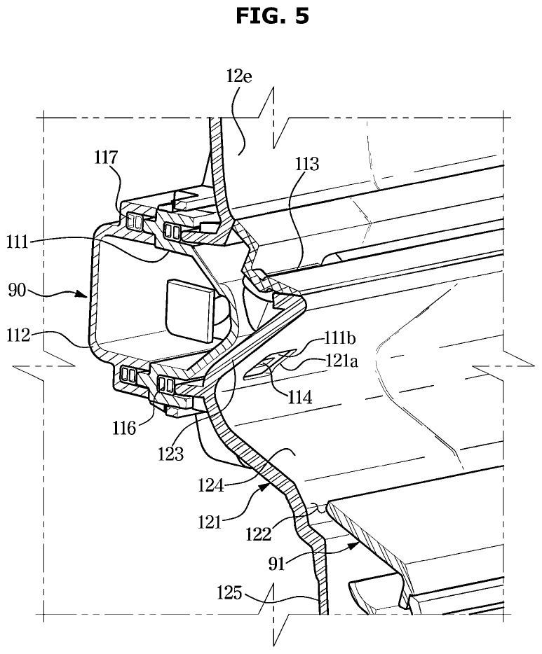

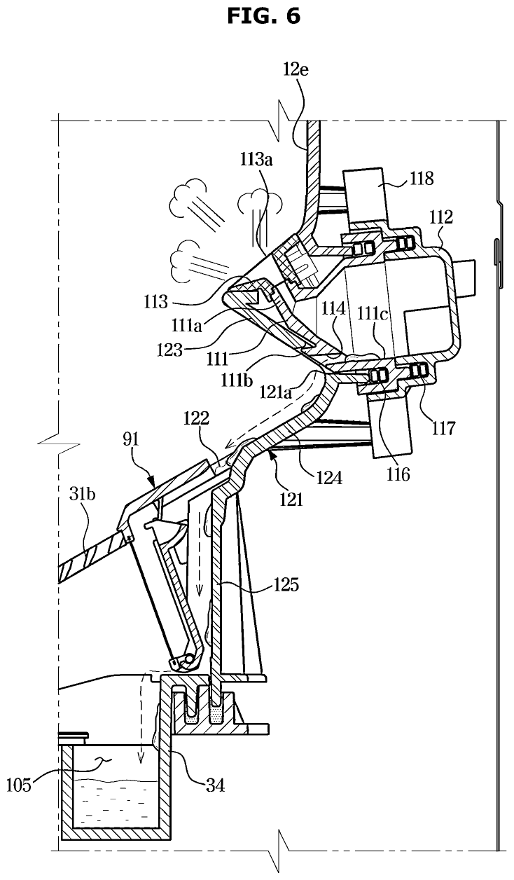

FIG. 5 is a partial sectional perspective view illustrating a portion in which a steam ejector of a steam generation device of a clothes care apparatus is disposed according to various embodiments. FIG. 6 is a diagram illustrating an enlarged view of a portion A of FIG. 3 according to various embodiments.

Referring to FIG. 5 and FIG. 6, the steam ejector 90 may be disposed at the rear lower portion of the chamber 30. The steam ejector 90 may spray steam supplied from the steam generator 73 into the chamber 30. The steam ejector 90 may be connected to the steam supply pipe 72. The steam ejector 90 may include a steam nozzle 111 and a nozzle cover 112.

The steam nozzle 111 may include a steam outlet 111a spraying steam into the chamber 30, and a condensate outlet 111b discharging condensate generated from the steam ejector 90 into the chamber 30.

The steam outlet 111a may extend toward the upper side of the chamber 30 where garments are placed. The steam outlet 111a may be formed to spray steam supplied through the steam supply pipe 72 toward the upper side of the chamber 30. A spray nozzle 113 may be disposed at an end of the steam outlet 111a.

The spray nozzle 113 may be formed to spray steam broadly. The spray nozzle 113 may be formed in such a way that a size of an opening increases along a direction in which steam is sprayed. A steam spray outlet 113a through which steam is discharged may be formed at an end of the spray nozzle 113.

The condensate outlet 111b may be formed to discharge condensate to the lower side of the chamber 30. The condensate outlet 111b may be inclined downward toward the chamber 30 to allow the condensate to be discharged by gravity. For example, a lower side 111c of the spray nozzle 113 may be inclined downward toward the chamber 30, and the condensate outlet 111b may extend downward from the lower side 111c of the spray nozzle 113.

A condensate outlet port 114 through which condensate flows may be formed in the condensate outlet 111b. Condensate generated from the steam supplied to the steam ejector 90 may move to the condensate outlet 111b along the lower side 111c by its own weight, and may be discharged to the chamber 30 along the condensate outlet port 114 of the condensate outlet 111b.

A first sealing member 116 may be positioned at a portion where the steam nozzle 111 and the rear side 12e of the inner cabinet 12 are coupled. The first sealing member 116 may prevent and/or reduce steam from leaking through the portion where the steam nozzle 111 and the inner cabinet 12 are coupled. The first sealing member 116 may be positioned at a portion where the steam nozzle 111 and a guide plate 121 are coupled. The first sealing member 116 may prevent and/or reduce steam from leaking through the portion where the steam nozzle 111 and the guide plate 121 are coupled.

The nozzle cover 112 may cover the rear of the steam nozzle 111. The nozzle cover 112 may include a nozzle fixing portion 118 for fixing the steam ejector 90 to the rear of the inner cabinet 12. The nozzle fixing portion 118 may be fixed to the guide plate 121.

A second sealing member 117 may be positioned at a portion where the steam nozzle 111 and the nozzle cover 112 are coupled. The second sealing member 117 may prevent and/or reduce steam from leaking through the portion where the steam nozzle 111 and the nozzle cover 112 are coupled.

The clothes care apparatus 1 may include the guide plate 121 to guide condensate discharged through the condensate outlet port 114 to the second duct 34 disposed in the machine room 40.

The guide plate 121 may be mounted on the inner cabinet 12, and may form a drain 122 that communicates the chamber 30 with the machine room 40. Condensate may be moved to the second duct 34 of the machine room 40 through the drain 122. As described above, the condensate moved to the second duct 34 of the machine room 40 may be guided to the first duct 33 through the second connection member 34a, and the condensate guided to the first duct 33 may be stored in the sump 105.

The guide plate 121 may include a seating portion 123 on which the steam ejector 90 is seated, a first guide portion 124 that guides the condensate discharged from the condensate outlet port 114 to the drain 122, and a second guide portion 125 that guides the condensate flowing into the machine room 40 through the drain 122 to the second duct 34.

The seating portion 123 may be inclined upward toward the chamber 30 to allow the steam nozzle 111 of the steam ejector 90 to be seated. The seating portion 123 may include an outlet insertion hole 121a into which the condensate outlet 111b of the steam nozzle 111 is inserted. The steam nozzle 111 may discharge condensate to the drain 122 as the condensate outlet 111b is inserted into the outlet insertion hole 121a.

The first guide portion 124 may be inclined downward from a lower end of the seating portion 123 toward the chamber 30. The first guide portion 124 may be inclined downward to allow the condensate discharged from the condensate outlet port 114 to move to the machine room 40 by its own weight. The drain 122 through which condensate flows into the machine room 40 may be disposed at a lower end of the first guide portion 124.

The second guide portion 125 may extend downward from a lower end of the first guide portion 124. The second guide portion 125 may extend from the first guide portion 124 toward the second duct 34. The second guide portion 125 may guide condensate flowing into the machine room 40 through the drain 122 to the second duct 34. The second guide portion 15 may be coupled to the second duct 34.

According to the above-described configuration, the clothes care apparatus 1 according to an embodiment of the disclosure may guide condensate, generated from the steam ejector 90, to the second duct 34 of the machine room 40 and move the condensate to the sump 105 through the guide plate 121 without a separate drainage device for moving the condensate to the sump 105, e.g., the clothes care apparatus 1 may have a relatively simple configuration.

In other words, in the clothes care apparatus 1 according to an embodiment of the disclosure, the condensate generated from the steam ejector 90 may sequentially pass through the second duct 34 and the first duct 33 by its own weight and then move to the water tank 80 by an operation of the sump pump 115, and thus the condensate generated from the steam ejector 90 may be recovered to the water tank 80 without a separate complicated device for recovering the condensate. The condensate generated from the steam ejector 90 may be collected in the sump 105 together with condensate generated from another component of the clothes care apparatus 1, and may be moved to the water tank 80. The clothes care apparatus 1 according to an embodiment of the disclosure may collect condensate at one location and recover the condensate to the water tank 80 through a relatively simple configuration without a separate device such as a hose for draining condensate at each component where the condensate is generated, and thus manufacturing costs may be reduced.

According to an embodiment, various condensates discharged from the steam generation device 70 may be stored in the sump 105. The various condensates discharged from the steam generation device 70 may include condensate discharged from the heat exchanger 41 and/or condensate discharged from the steam ejector 90.

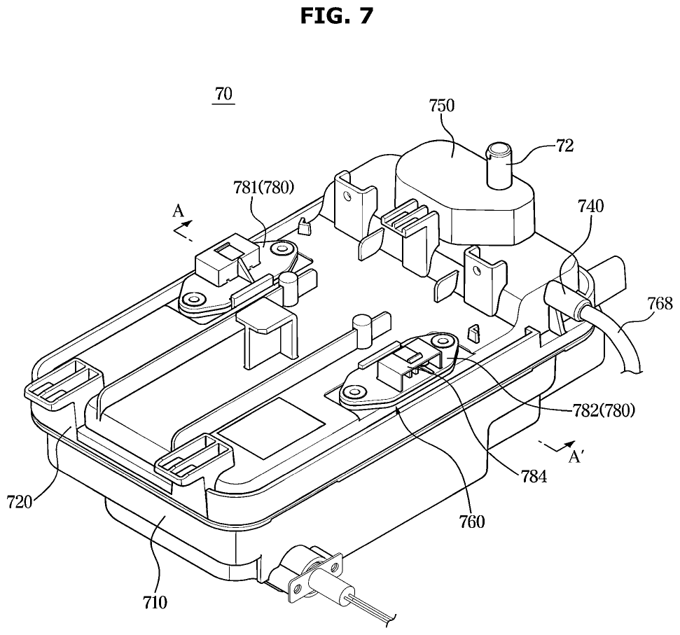

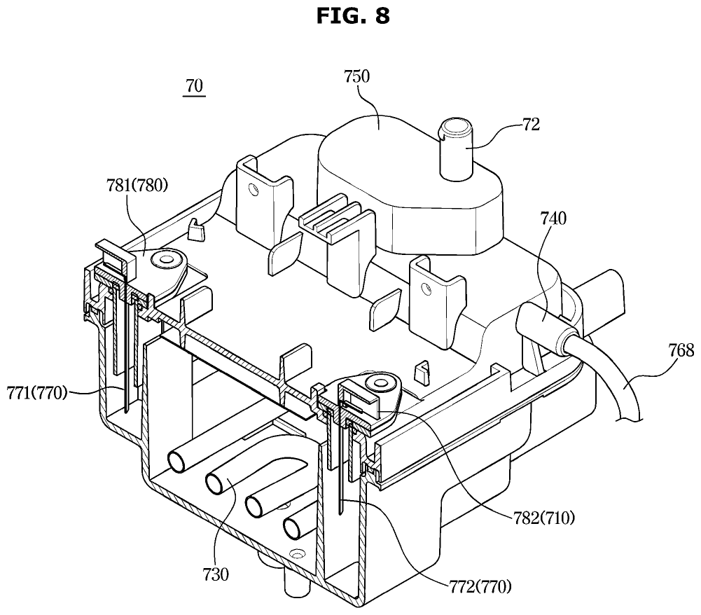

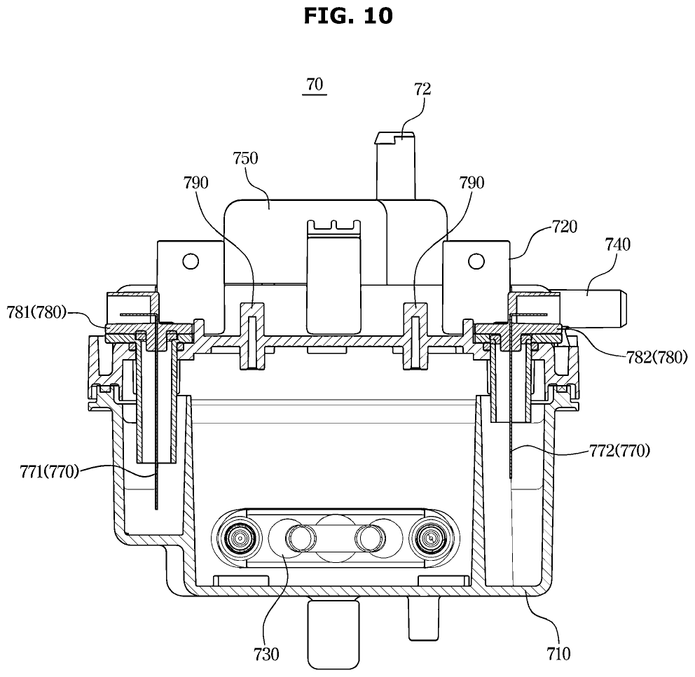

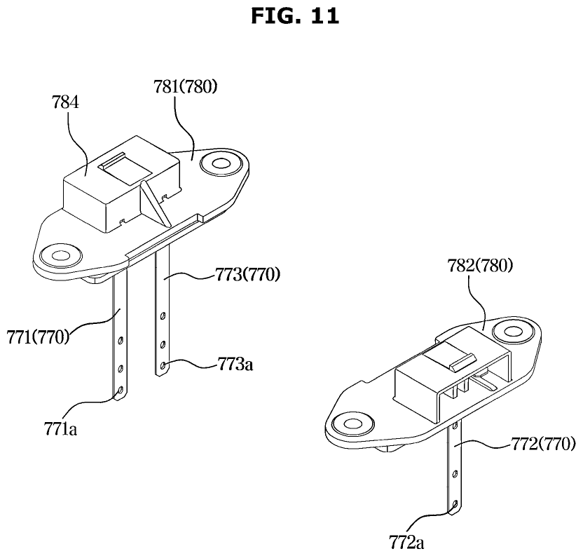

FIG. 7 is a perspective view of a steam generator of a steam generation device of a clothes care apparatus according to various embodiments. FIG. 8 is a partial sectional perspective view of the steam generation device taken along line A-A′ of FIG. 7 according to various embodiments. FIG. 9 is a side cross-sectional view of a steam generator of a steam generation device of a clothes care apparatus according to various embodiments. FIG. 10 is a front cross-sectional view of a steam generator of a steam generation device of a clothes care apparatus according to various embodiments. FIG. 11 includes perspective views illustrating an example of an electrode sensor for detecting water level in a steam generation device of a clothes care apparatus according to various embodiments.

Referring to FIG. 7, FIG. 8, FIG. 9, FIG. 10 and FIG. 11, the steam generation device 70 may include the case 710 for storing water therein and a cover 720 coupled to an upper portion of the case 710. For example, the steam generator 73 may include the case 710 for storing water therein and the cover 720 coupled to the upper portion of the case 710.

The steam generation device 70 may include a contamination level sensor 765 for detecting a contamination level of water stored in the case 710. The contamination level of the water stored in the case 710 may include an ion concentration of the water stored in the case 710.

The contamination level sensor 765 may be positioned in the case 710. The contamination level sensor 765 may include an electrical conductivity sensor. The electrical conductivity sensor may measure an electrical conductivity of the water. A salinity or ion concentration of the water may be identified according to the electrical conductivity of the water.

According to the various embodiments, the contamination level sensor 765 may be replaced by an electrode sensor 770. In an embodiment, the contamination level sensor 765 may include a low water level electrode 771 and a common electrode 773 of the electrode sensor 770. By forming a potential difference in the low water level electrode 771 and the common electrode 773 of the electrode sensor 770, and measuring a current flowing in the low water level electrode 771 and the common electrode 773, the electrical conductivity of the water stored in the case 710 may be measured.

The case 710 may be supplied with water from the water tank 80 through a water supply connection member 768. For example, the water required to generate steam may be moved from the water tank 80 to the case 710 and may be stored. The water supply connection member 768 may include a component capable of forming a flow path, such as a hose and/or pipe. The clothes care apparatus 1 may include a water supply pump 110 (see FIG. 14) for supplying water stored in the water tank 80 to the steam generation device 70 through the water supply connection member 768.

The case 710 may be formed in a substantially rectangular parallelepiped shape, without being limited thereto.

The case 710 may be coupled to the cover 720, and may form a storage space inside. The water required to generate steam may be stored in the storage space formed by coupling the case 710 to the cover 720.

The steam generation device 70 may include the heater 730 disposed inside the case 710 to heat the water stored in the case 710.

The heater 730 may be installed adjacent to a bottom side of the case 710 to heat the water in the case 710 regardless of whether the water level of the water in the case 710 is high or low. The heater 730 may be installed to directly heat the water in a state where the heater 730 is completely submerged in the water as water flows into the case 710.

The heater 730 may include a sheath heater that has high thermal efficiency and may heat water in a relatively short time, without being limited thereto. For example, the heater 730 may include a coil heater that heats water stored in the case 710 outside of the case 710, or the like.

The case 710 may be provided with a separate temperature sensor (not shown) to measure a temperature of the water stored in the case 710. In addition, a heater temperature sensor (not shown) such as a thermo-fuse may be installed in the case 710 to prevent or avoid the heater 730 being damaged by overheating. However, the disclosure is not limited thereto.

The cover 720 may include a water supply portion 740 coupled to the water supply connection member 768, and a discharge portion 750 connected to the steam supply pipe 72 for supplying the chamber 30 with steam generated by heating the water introduced into the case 710 with the heater 730.

The steam generation device 70 may include a water level sensor 760 that is installed on the cover 720 and detects a water level in the case 710.

The water level sensor 760 may detect the level of water stored in the case 710. In a case where the level of the water stored in the case 710 detected by the water level sensor 760 is higher than a reference value, the clothes care apparatus 1 may stop supplying water to the steam generation device 70 and operate the heater 730 to generate steam.

The water level sensor 760 may include the electrode sensor 770 extending toward the bottom side of the case 710. In addition, the water level sensor 760 may include a housing 780 that may support the electrode sensor 770 and is detachably coupled to the cover 720.

The electrode sensor 770 may be installed at an appropriate height to be spaced apart from the bottom side of the case 710 to detect the level of water to be stored in the case 710.

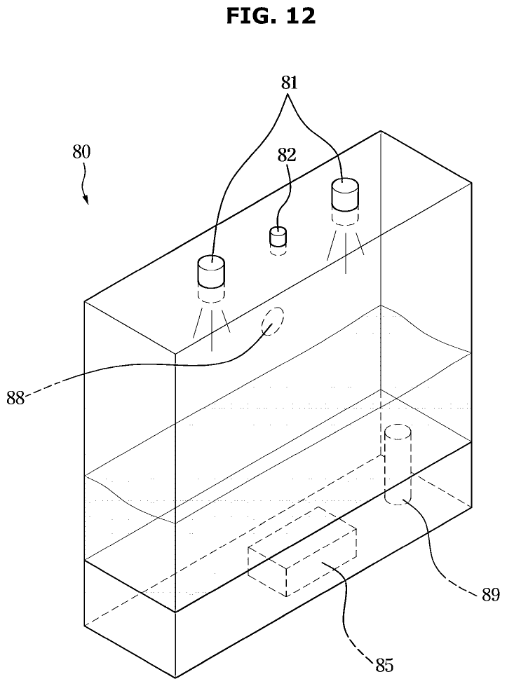

The housing 780 may be fixed to the cover 720 by a fixing member 790 (e.g., a bolt or the like). A socket portion 784 may be positioned on an upper side of the housing 780 for electrical connection between the water level sensor 760 and a controller 250 (see FIG. 12).

The housing 780 may include a first housing 781 and a second housing 782. The first housing 781 and the second housing 782 may each be coupled to both sides of the cover 720.

The electrode sensor 770 may include the low water level electrode 771 detecting a low water level in the case 710, and a high water level electrode 772 detecting a high water level in the case 710.

The low water level electrode 771 may be positioned above the heater 730. An upper end of the low water level electrode 771 may be supported by the first housing 781, and a lower end of the low water level electrode 771 may be positioned above the heater 730 to be spaced apart from the heater 730.

The low water level electrode 771 may include a first detection portion 771a. The first detection portion 771a may be positioned at the lower end of the low water level electrode 771 and may detect the water level in the case 710.

The high water level electrode 772 may be positioned above the heater 730. An upper end of the high water level electrode 772 may be supported by the second housing 782, and a lower end of the high water level electrode 772 may be positioned above the heater 730 to be spaced apart from the heater 730.

The high water level electrode 772 may include a second detection portion 772a. The second detection portion 772a may be positioned at the lower end of the high water level electrode 772 and may detect the water level in the case 710.

The high water level electrode 772 may be formed to have a shorter length than the low water level electrode 771. According to the above configuration, the second detection portion 772a may be positioned at a higher position than the first detection portion 771a.

The electrode sensor 770 may include the common electrode 773.

The common electrode 773 may be supported by the first housing 781. For example, the common electrode 773 may be positioned adjacent to the low water level electrode 771. In addition, the common electrode 773 may have the same length as the low water level electrode 771.

The common electrode 773 may include a third detection portion 773a. The third detection portion 773a may be positioned at a lower end of the common electrode 773, and may detect the water level in the case 710.

The common electrode 773 may be electrically connected to at least one of the low water level electrode 771 or the high water level electrode 772 via water. According to the above configuration, the water level sensor 760 may detect the water level in the case 710.

Water may flow into the case 710 through the water supply portion 740. The water introduced into the case 710 may be heated by the heater 730 and converted into steam.

Steam may be supplied to the steam ejector 90 through the discharge portion 750 of the case 710. The steam ejector 90 may spray steam into the chamber 30. The steam sprayed into the chamber 30 may increase a humidity of air in the chamber 30. The humid air in the chamber 30 may be dehumidified by the heat exchanger 41. The heat exchanger 41 may dehumidify the humid air in the chamber 30 and discharge condensate. The condensate discharged from the heat exchanger 41 and/or the condensate discharged from the steam ejector 90 may be stored in the sump 105. The condensate stored in the sump 105 may be recovered to the water tank 80.

FIG. 12 is a perspective view illustrating a water tank of a clothes care apparatus according to various embodiments.

Referring to FIG. 12, the clothes care apparatus 1 according to an embodiment may include the sterilization device 81 for sterilizing water stored in the water tank 80.

The sterilization device 81 may include an ultraviolet (UV) emitter that emits ultraviolet rays.

The UV emitter may emit ultraviolet rays in a direction toward the water stored in the water tank 80.

In an embodiment, the UV emitter may be positioned at a location where ultraviolet rays may be emitted toward the water tank 80 when the water tank 80 is inserted into the main body 10. In an embodiment, the UV emitter may be positioned in the water tank 80.

For example, as shown in FIG. 12, the UV emitter may be positioned on an upper side of the water tank 80 to emit ultraviolet rays toward a bottom side of the water tank 80. The bottom side of the water tank 80 may include a bottom side of a space containing water.

However, the position of the UV emitter is not limited to the example shown in FIG. 12, and in a case where one side (e.g., the bottom or side) of the water tank 80 is made of a transparent material, the UV emitter may be positioned close to the one side (e.g., the bottom or side) of the water tank 80 to emit ultraviolet rays toward the one side (e.g., the bottom or side) of the water tank 80.

The clothes care apparatus 1 according to an embodiment may include a water level sensor 82 detecting a water level of the water tank 80 (water level of the water stored in the water tank 80).

The water level sensor 82 may collect sensor data related to the water level of the water tank 80. The water level sensor 82 may transmit the sensor data related to the water level of the water tank 80 to the controller 250. The controller 250 may determine the water level of the water tank 80 based on the sensor data related to the water level of the water tank 80 received from the water level sensor 82.

In an embodiment, the water level sensor 82 may include a non-contact sensor such as a capacitance sensor, an ultrasonic sensor, and/or an optical sensor.

The capacitance sensor may detect the water level of the water tank 80 by detecting a change in electrical capacitance of the water tank 80 according to a change in the water level.

The ultrasonic sensor may detect the water level of the water tank 80 by measuring a time it takes for an ultrasonic signal generated by the ultrasonic sensor to be reflected back to the water stored in the water tank 80.

The optical sensor may detect the water level of the water tank 80 by measuring a time it takes for light emitted from the optical sensor to be reflected back to the water stored in the water tank 80.

In an embodiment, the water level sensor 82 may be positioned in a space that accommodates the water tank 80. In an embodiment, the water level sensor 82 may be positioned in the water tank 80.

The water level sensor 82 is not limited to the non-contact sensor, and according to various embodiments, the water level sensor 82 may include a pressure sensor detecting a pressure of the water stored in the water tank 80, or a contact sensor such as the electrode sensor described above.

In an embodiment, the clothes care apparatus 1 may include a microbial detection sensor 85 detecting microorganisms attached to the water tank 80. In an embodiment, the microbial detection sensor 85 may be positioned in a space that accommodates the water tank 80. In an embodiment, the microbial detection sensor 85 may be positioned in the water tank 80.

The microbial detection sensor 85 may collect sensor data related to the amount of microorganisms attached to the water tank 80. The microbial detection sensor 85 may transmit the sensor data related to the amount of microorganisms attached to the water tank 80 to the controller 250. The controller 250 may determine a microbial contamination level based on the sensor data related to the amount of microorganisms attached to the water tank 80 received from the microbial detection sensor 85.

The microbial detection sensor 85 may include at least one sensor that may detect the amount of microorganisms attached to one side (e.g., bottom side) of the water tank 80.

Examples of the microbial detection sensor 85 will be described in greater below with reference to FIG. 13A and FIG. 13B.

The water tank 80 according to an embodiment may include a drain port 88 for recovering water discharged from the steam generation device 70, and a water supply port 89 for supplying water to the steam generation device 70.

The drain port 88 may be connected to a connecting member (e.g., a pipe or a hose) connecting the sump 105 and the water tank 80.

The water supply port 89 may be connected to a connecting member (e.g., a pipe or a hose) connecting the steam generation device 70 and the water tank 80.

The clothes care apparatus 1 according to an embodiment may further include a water quality sensor 86 detecting a water quality of the water stored in the water tank 80.

The water quality sensor 86 may collect sensor data related to the water quality of the water stored in the water tank 80. The water quality may include turbidity, ion concentration, acidity, and the like of the water.

The water quality sensor 86 may include a turbidity sensor detecting a turbidity of water stored in the water tank 80, an electric conductivity sensor detecting an ion concentration, and/or a pH sensor detecting an acidity.

According to various embodiments, electronic components, such as the sterilization device 81, the microbial detection sensor 85, the water level sensor 82, and/or the water quality sensor 86, may be positioned in the water tank 80 or may be positioned in the main body 10 of the clothes care apparatus 1.

In a case where electronic components such as the sterilization device 81, the microbial detection sensor 85, the water level sensor 82, and/or the water quality sensor 86 are positioned in the water tank 80, the water tank 80 may further include a power supply for receiving power from the main body 10 of the clothes care apparatus 1.

The power supply of the water tank 80 may include a power terminal that may be electrically connected to a power source provided in the main body 10 of the clothes care apparatus 1 in a state where the water tank 80 is mounted on the main body 10 of the clothes care apparatus 1.

Although not illustrated, the water tank 80 may include a door that may open and close the space for storing water. After opening the door of the water tank 80, a user may remove the water stored in the water tank 80 or refill the water tank 80 with the water. In addition, the user may clean the inside of the water tank 80 after opening the door of the water tank 80.

FIG. 13A and FIG. 13B are diagrams illustrating an example of a microbial detection sensor according to various embodiments.

Referring to FIG. 13A, in an embodiment, a bottom side 80b of the water tank 80 may have a transparent area 80a. The bottom side 80b of the water tank 80 may include a bottom side of a space containing water. The transparent area 80a may be made of a transparent material such as quartz or glass.

In an embodiment, the bottom side 80b of the water tank 80 may be differentiated from a bottom side of the housing forming the water tank 80. In an embodiment, the bottom side 80b of the water tank 80 may be the bottom side of the housing forming the water tank 80.

The microbial detection sensor 85 may include a light emitter 83a to emit light toward the bottom side 80b of the water tank 80, and a light receiver 83b disposed below the transparent area 80a.

In an embodiment, the light emitter 83a emitting light toward the bottom side 80b of the water tank 80 may be a light emitter that emits visible light. In this instance, the light emitter 83a may refer to a light source separate from the UV emitter of the sterilization device 81.

In an embodiment, the light emitter 83a emitting light toward the bottom side 80b of the water tank 80 may be a laser emitter that emits laser. In this instance, the light emitter 83a may refer to a light source separate from the UV emitter of the sterilization device 81.

In an embodiment, the light emitter 83a emitting light toward the bottom side 80b of the water tank 80 may be the sterilization device 81 (UV emitter).

The light receiver 83b may detect the amount of light emitted from the light emitter 83a. For example, the light receiver 83b may include a light sensor, photo sensor, laser light receiver, and/or image sensor.

Light (e.g., visible light, ultraviolet rays, or laser) emitted from the light emitter 83a may be transmitted to the light receiver 83b through the transparent area 80a, and the light receiver 83b may measure the amount of light transmitted through the transparent area 80a.

In a case where microorganisms are attached to the bottom side 80b of the water tank 80, e.g., a biofilm is formed, the amount of light received by the light receiver 83b decreases.

For example, the sensor data related to the amount of microorganisms attached to the water tank 80 may include light amount data collected by the light receiver 83b.

In a case where microorganisms are attached to the bottom side 80b of the water tank 80, e.g., a biofilm is formed, brightness or saturation of an image generated by the light collected by the light receiver 83b decreases.

For example, the sensor data related to the amount of microorganisms attached to the water tank 80 may include brightness data and/or saturation data of the image generated by the light collected by the light receiver 83b.

Referring to FIG. 13B, in an embodiment, a pair of electrode sensors 84a may be provided on the bottom side 80b of the water tank 80.

The microbial detection sensor 85 may include the pair of electrode sensors 84a positioned on the bottom side of the water tank 80, and a resistance sensor 84b measuring a resistance value between the pair of electrode sensors 84a.

In a case where microorganisms are attached to the bottom side 80b of the water tank 80, e.g., a biofilm is formed, the resistance value between the electrode sensors 84a increases.

For example, the sensor data related to the amount of microorganisms attached to the water tank 80 may include data about the resistance value between the electrode sensors 84a collected by the resistance sensor 84b.

The microbial detection sensor 85 is not limited to the examples described above, and any sensor capable of collecting sensor data related to the amount of microorganisms attached to the water tank 80 may be employed as the microbial detection sensor 85.

FIG. 14 is a diagram illustrating an example of a steam generation system according to various embodiments.

Referring to FIG. 14, a steam generation system 100 may include the steam generation device 70, the sump 105, the water purification filter 109, and the water tank 80.

According to an embodiment, the steam generation system 100 may include at least one circulation pump 120 for pumping water in the steam generation device 70 to the sump 105 or the water purification filter 109.

In the example illustrated in FIG. 14, the circulation pump 120 pumps water in the steam generation device 70 to the sump 105. However, according to various embodiments, the circulation pump 120 may directly connect the steam generation device 70 and the water purification filter 109. For example, the circulation pump 120 may directly pump water in the steam generation device 70 to the water purification filter 109.

The water purification filter 109 may be disposed upstream of the water tank 80. The water supplied to the water purification filter 109 may be filtered by the water purification filter 109 and move to the water tank 80 disposed downstream of the water purification filter 109. Pumping water to the water purification filter 109 may include pumping water to the water tank 80.

The steam generation system 100 according to an embodiment may include the sump pump 115 for pumping water stored in the sump 105 to the water purification filter 109.

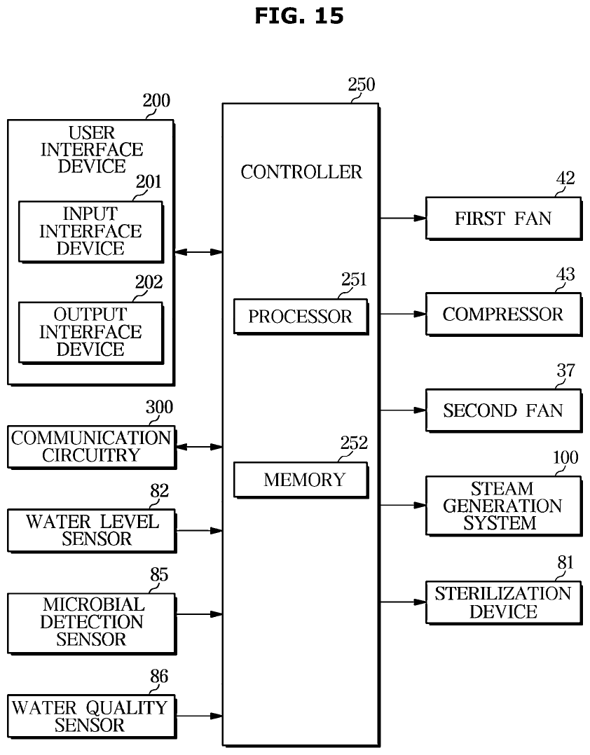

In an embodiment, the controller 250 (see FIG. 15) may operate the sump pump 115 for a preset period of time based on completion of a clothes care process (e.g., steam process) or clothes course.

In an embodiment, the controller 250 may operate the sump pump 115 based on completion of an operation of the water supply pump 110.

The steam generation system 100 according to an embodiment may include the water supply pump 110 for pumping water stored in the water tank 80 to the steam generation device 70.

The steam generation system 100 may include connection members to connect the steam generation device 70, the sump 105, the water purification filter 109, and the water tank 80. The steam generation system 100 may include flow paths formed by the connection members configured to connect the steam generation device 70, the sump 105, the water purification filter 109, and the water tank 80. The steam generation system 100 may include at least one valve 130 for opening and closing the flow paths formed by the connection members configured to connect the steam generation device 70, the sump 105, the water purification filter 109, and the water tank 80.

The steam generation system 100 may include a valve 130a that opens and closes a flow path connecting the sump 105 and the water purification filter 109, a valve 130b that opens and closes a flow path connecting the sump 105 and the steam generation device 70, and a valve 130c that opens and closes a flow path connecting the water tank 80 and the steam generation device 70. According to various embodiments, at least one valve 130 among the plurality of valves 130a, 130b, and 130c may be omitted.

For example, in a case where the water stored in the sump 105 does not naturally flow into the water purification filter 109 due to factors such as gravity, the valve 130a that opens and closes the flow path connecting the sump 105 and the water purification filter 109 may be omitted. As another example, in a case where the water stored in the steam generation device 70 does not naturally flow into the sump 105 due to factors such as gravity, the valve 130b that opens and closes the flow path connecting the steam generation device 70 and the sump 105 may be omitted. As still another example, in a case where the water stored in the water tank 80 does not naturally flow into the steam generation device 70 due to factors such as gravity, the valve 130c that opens and closes the flow path connecting the water tank 80 and the steam generation device 70 may be omitted.

In an embodiment, operating the sump pump 115 may include opening the valve 130a connecting the sump 105 and the water purification filter 109. In an embodiment, operating the circulation pump 120 may include opening the valve 130b connecting the steam generation device 70 and the sump 105. In an embodiment, operating the water supply pump 110 may include opening the valve 130c connecting the water tank 80 and the steam generation device 70.

The controller 250 may operate the circulation pump 120 based on a preset condition being satisfied. The preset condition may include a contamination level of the water in the steam generation device 70 being greater than or equal to a preset contamination level and/or a cumulative storage time of the water in the steam generation device 70 reaching a preset time. For example, the preset condition may include an event in which the water in the steam generation device 70 is likely to be contaminated.

In a case where the controller 250 operates the circulation pump 120, the controller 250 may operate the sump pump 115 and the water supply pump 110 together.

In a case where the circulation pump 120, the sump pump 115, and the water supply pump 110 operate together, the water in the steam generation device 70 may pass through the sump 105 and the water purification filter 109, and may be recovered to the water tank 80, and then recovered back to the steam generation device 70.

In an embodiment, the water discharged from the steam generation device 70 may include water moving from the steam generation device 70 to the water tank 80 by an operation of the circulation pump 120.

In an embodiment, in a case where the circulation pump 120 and the water supply pump 110 operate together, the amount of water discharged per unit time of the circulation pump 120 and the water supply pump 110 may be the same.

According to an embodiment of the disclosure, in the clothes care apparatus 1, the water recovered to the water tank 80 after being filtered by the water purification filter 109 may be sterilized by the sterilization device 81, and may be supplied back to the steam generation device 70, and thus the water stored in the water tank 80 may be reused continuously.

FIG. 15 is a block diagram illustrating an example configuration of a clothes care apparatus according to various embodiments.

Referring to FIG. 15, the clothes care apparatus 1 according to an embodiment may include the first fan 42, the compressor 43, the second fan 37, the steam generation system (e.g., including a steam generator) 100, a user interface device (e.g., including interface circuitry) 200, communication circuitry 300, and/or the controller (e.g., including processing circuitry) 250.

The first fan 42 may allow air in the chamber 30 to be discharged back to the chamber 30 through the machine room 40, the evaporator 41a, and the condenser 41b. The first fan 42 may operate based on a control signal from the controller 250.

The compressor 43 may compress refrigerant supplied to the heat exchanger 41. The compressor 43 may operate based on a control signal from the controller 250.

The second fan 37 may circulate the air in the chamber 30 back into the chamber 30 through the second airflow outlet 32b or the garment support member 50. The second fan 37 may operate based on a control signal from the controller 250.

The steam generation system 100 may supply steam to the chamber 30.

The steam generation system 100 may include the water tank 80 and the steam generation device 70, including, for example, a steam generator, that generates steam using water supplied from the water tank 80 and sprays the generated steam into the chamber 30.

As described above, the steam generation device 70 may include the heater 730. The heater 730 may operate based on a control signal from the controller 250.

The steam generation system 100 may include various components for supplying water stored in the water tank 80 to the steam generation device 70. For example, the steam generation system 100 may include the water supply pump 110 and at least one connection member (e.g., water supply connection member 768) for supplying the water stored in the water tank 80 to the steam generation device 70.

The steam generation system 100 may include various components for supplying water in the steam generation device 70 and/or water stored in the sump 105 to the water tank 80.

In an embodiment, the steam generation system 100 may include the circulation pump 120 and at least one connection member for supplying water in the steam generation device 70 to the water tank 80. The connection member for supplying water in the steam generation device 70 to the water tank 80 may be connected to the water purification filter 109.

In an embodiment, the steam generation system 100 may include the circulation pump 120 and at least one connection member for supplying water in the steam generation device 70 to the sump 105.

In an embodiment, the steam generation system 100 may include at least one connection member (e.g., first connection member 33a) for supplying water stored in the sump 105 to the water tank 80, and the sump pump 115. The at least one connection member for supplying water stored in the sump 105 to the water tank 80 may be connected to the water purification filter 109.

The steam generation system 100 may further include at least one valve 130 configured to open and close at least one flow path formed by the at least one connection member for supplying water in the steam generation device 70 to the water tank 80 and/or the sump 105, and/or at least one flow path formed by the at least one connection member for supplying water stored in the sump 105 to the water tank 80, and/or at least one flow path formed by the at least one connection member for supplying water stored in the water tank 80 to the steam generation device 70.

The steam generation system 100 may include the water purification filter 109 for purifying and/or softening the water in the steam generation device 70 and/or the water stored in the sump 105 before supplying the water to the water tank 80.

The water purification filter 109 may include a filter capable of removing ions (e.g., ion exchange resin filter, electrochemical filter) and/or a filter required for water purification (e.g., free carbon filter, hollow membrane filter, etc.).

According to an embodiment, the steam generation system 100 may further include the sterilization device (e.g., a UV emitter) 81 for sterilizing water stored in the water tank 80. The sterilization device for sterilizing the water stored in the water tank 80 may include an UV emitter.

In an embodiment, the sterilization device 81 may be positioned in the water tank 80. For example, the sterilization device 81 may be a component of the steam generation system 100.

In an embodiment, the sterilization device 81 may be positioned in the main body 10 of the clothes care apparatus 1. For example, the sterilization device 81 may be a component of the clothes care apparatus 1.

As described above, the sterilization device 81 may include the UV emitter. The UV emitter may emit ultraviolet rays toward the water stored in the water tank 80.

The sterilization device 81 may be controlled based on a control signal from the controller 250.

Various components (e.g., heater 730, water supply pump 110, sump pump 115, circulation pump 120, valve 130, and/or sterilization device 81) of the steam generation system 100 may be controlled based on a control signal from the controller 250.

The controller 250 may include a processor (e.g., including processing circuitry) 251 and/or a memory 252 and control an operation of the sterilization device 81. In an embodiment, the controller 250 may control an operation time of the sterilization device 81. Controlling an operation time of the sterilization device 81 may include controlling an emission time during which the UV emitter emits ultraviolet rays.

The controller 250 may control the operation time of the sterilization device 81 based on sensor data collected from at least one sensor 82, 85, and 86.

The user interface device 200 may include various interface circuitry and allow a user and the clothes care apparatus 1 to interact with each other.

The user interface device 200 may include at least one input interface device 201 and at least one output interface device 202.

The at least one input interface device 201 may convert sensory information received from a user into an electrical signal.

The at least one input interface device 201 may include a power button, a course selection button, an operation/pause button, and/or a communication button.

Each button may include a visual indicator (e.g., text, icon, etc.) that may indicate its function.

The power button is a button for turning on or off the power of the clothes care apparatus 1.

The course selection button is a button for selecting a course for the clothes care apparatus 1.

The course selection button may include a button for selecting a course for caring for garments stored in the chamber 30.

Upon selection of the course selection button, at least one course corresponding to clothes care may be displayed on the output interface device 202 (e.g., display), and the user may select a desired course using a direction selection button. The at least one course may include a variety of courses, such as a standard course, bulky item care course, sterilization course, fine dust course, quick course, school uniform course, denim course, coat course, wool/knit course, suit course, and the like.

Upon selection of the operation button after a course for clothes care is selected, the controller 250 may control components (e.g., compressor 43, steam generation system 100, first fan 42 and/or second fan 37) of the clothes care apparatus 1 according to an algorithm of the selected course to perform the selected course.

The operation/pause button is a button for operating the selected course or temporarily stopping a running course.

The communication button is a button for communication settings of the clothes care apparatus 1. Through the communication button, the clothes care apparatus 1 may connect to a nearby Access Point (AP). The clothes care apparatus 1 may communicate with an external device, such as a server, user device, and other home appliances, through the nearby access point.

The at least one input interface device 201 may include, for example, a tact switch, a push switch, a slide switch, a toggle switch, a micro switch, a touch switch, a touch pad, a touch screen, a jog dial, and/or a microphone.

In the disclosure, “button” may be replaced by an user interface (UI) element, a tact switch, a push switch, a slide switch, a toggle switch, a micro switch, a touch switch, a touch pad, a touch screen, a jog dial, and/or a microphone.

The at least one output interface device 202 may generate sensory information and convey information related to operations of the clothes care apparatus 1 to the user.

For example, the at least one output interface device 202 may convey information related to a clothes care course, operation time of the clothes care apparatus 1, and settings of the clothes care apparatus 1 to the user. Information about operations of the clothes care apparatus 1 may be output through a display, an indicator, voice, or the like. The at least one output interface device 202 may include, for example, a Liquid Crystal Display (LCD) panel, a Light Emitting Diode (LED) panel, an indicator, a speaker, and the like.

The communication circuitry 300 may communicate with an external device (e.g., a server, a user device, and/or a home appliance) for wired and/or wireless communication.

The communication circuitry 300 may include at least one of a short-range wireless communication module or a long-range wireless communication module.

The communication circuitry 300 may transmit data to an external device or receive data from the external device. For example, the communication circuitry 300 may establish communication with a server, a user device, and/or a home appliance, and transmit and receive various types of data.

For the communication, the communication circuitry 300 may establish a direct (e.g., wired) communication channel or a wireless communication channel between external devices, and support the performance of the communication through the established communication channel. According to an embodiment, the communication circuitry 300 may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA) or a second network (e.g., a long-range wireless communication network such as a legacy cellular network, a 5G network, a next-generation communication network, the Internet, or a computer network (e.g., LAN or WAN)). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA communication module, a Wi-Fi Direct (WFD) communication module, an ultrawideband (UWB communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, or a server on a mobile communication network.

In an embodiment, the communication circuitry 300 may communicate with an external device such as a server, a user device and other home appliances through a nearby access point (AP). The access point may connect a local area network (LAN), to which the clothes care apparatus 1, another home appliance, and/or a user device is connected, to a wide area network (WAN) to which a server is connected. The clothes care apparatus 1, the other home appliance, and/or the user device may be connected to the server through the wide area network (WAN).

The water level sensor 82 may collect sensor data related to a water level of the water tank 80. The sensor data collected by the water level sensor 82 may be transmitted to the controller 250.

The microbial detection sensor 85 may collect sensor data related to the amount of microorganisms attached to the water tank 80. The sensor data collected by the microbial detection sensor 85 may be transmitted to the controller 250.

The water quality sensor 86 may collect sensor data related to a water quality of the water stored in the water tank 80. The sensor data collected by the water quality sensor 86 may be transmitted to the controller 250.

The controller 250 may process data collected from various components of the clothes care apparatus 1 (e.g., user interface device 200, communication circuitry 300, water level sensor 82, microbial detection sensor 85, and water quality sensor 86). The controller 250 may process user input entered through the user interface device 200 and/or the communication circuitry 300, and may perform operations corresponding to the user input.

For example, based on receiving a user input to start a clothes care course from the user interface device 200, the controller 250 may control components (e.g., first fan 42, compressor 43, second fan 37, and/or steam generation system 100) of the clothes care apparatus 1 to perform the clothes care course according to a preset algorithm.

The clothes care courses may include s steam process.

The controller 250 may control the steam generation system 100 to perform the steam process. For example, the controller 250 may control the water supply pump 110 to supply water stored in the water tank 80 to the steam generation device 70 during the steam process. In an embodiment, the controller 250 may control the water supply pump 110 to supply the water stored in the water tank 80 to the steam generation device 70, based on a level of water in the steam generation device 70 being detected as a low water level by the water level sensor 760 during the steam process.

The controller 250 may operate the heater 730 to heat the water in the steam generation device 70 during the steam process.

In an embodiment, the controller 250 may control the sump pump 115 to pump the water stored in the sump 105 to the water purification filter 109 in response to completion of the clothes care course.

Once the water stored in the sump 105 is pumped to the water purification filter 109, the water stored in the sump 105 may be filtered by the water purification filter 109 and recovered to the water tank 80 disposed downstream of the water purification filter 109.

In an embodiment, the controller 250 may operate the sterilization device 81 in response to completion of the clothes care course. For example, in response to completion of the clothes care course, the controller 250 may operate the sterilization device 81 for a target time determined based on the sensor data collected by at least one sensor 82, 85, and 86.

In an embodiment, the controller 250 may operate the circulation pump 120 based on a preset condition being satisfied.

The preset condition may include a contamination level of the water in the steam generation device 70 being greater than or equal to a preset contamination level. The preset condition may include a cumulative storage time of water in the steam generation device 70 reaching a preset time. The preset time may be a predefined time and may be changed based on user input received through the user interface device 200 and/or the communication circuitry 300.

The cumulative storage time of water in the steam generation device 70 may include a period during which the steam generation system 100 does not perform a circulation process.

In an embodiment, the controller 250 may operate the sump pump 115 together with the water supply pump 110, in a case where the circulation pump 120 is operated for the circulation process.

In an embodiment, the controller 250 may operate the water supply pump 110 based on a water level measured by the water level sensor 760. For example, based on a low water level being detected by the water level sensor 760, the controller 250 may operate the water supply pump 110 until a high water level is detected by the water level sensor 760.

The controller 250 may include hardware such as a Central Processing Unit (CPU), micom, or memory, and software such as a control program. For example, the controller 250 may include at least one memory 252 for storing an algorithm and program-type data for controlling the operation of components in the clothes care apparatus 1, and at least one processor 251 configured to perform the above-described operations and operations to be described in greater detail below using the data stored in the at least one memory 252. The memory 252 and the processor 251 may each be implemented as separate chips. The processor 251 may include one or more processor chips or may include one or more processing cores. The memory 252 may include one or more memory chips or one or more memory blocks. The memory 252 and the processor 251 may be implemented as a single chip. The processor 251 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller 250 may be electrically connected to the first fan 42, the compressor 43, the second fan 37, the steam generation system 100, the sterilization device 81, the water level sensor 82, the microbial detection sensor 85, the water quality sensor 86, the user interface device 200, and/or the communication circuitry 300.

The components shown in FIG. 15 are simply examples of an example configuration of the clothes care apparatus 1 according to an embodiment. The clothes care apparatus 1 according to an embodiment may further include other components in addition to the components shown in FIG. 15, and may not include some of the components shown in FIG. 15.

For example, the clothes care apparatus 1 according to an embodiment may not include the water quality sensor 86. According to various embodiments, the water quality sensor 86 may be replaced with the contamination level sensor 765 for detecting a contamination level of water in the steam generation device 70. For example, in an embodiment, the controller 250 may control the sterilization device 81 based on sensor data collected from the contamination level sensor 765 for detecting a contamination level of water in the steam generation device 70.

As another example, the clothes care apparatus 1 according to an embodiment may further include a mounting detection sensor for detecting whether the water tank 80 is mounted. The mounting detection sensor may detect whether the water tank 80 is withdrawn from and/or mounted to the clothes care apparatus 1.

In an embodiment, the controller 250 may stop an operation of the sterilization device 81 based on the water tank 80 being withdrawn from the main body 10 during the operation of the sterilization device 81. Stopping the operation of the sterilization device 81 may include temporarily stopping the operation of the sterilization device 81 and/or completely stopping the operation of the sterilization device 81.

In an embodiment, based on the water tank 80 being withdrawn from the main body 10 during the operation of the sterilization device 81, the controller 250 may stop an operation of the sterilization device 81, and then operate the sterilization device 81 for a remaining period of time based on the water tank 80 being mounted to the main body 10.

In an embodiment, the controller 250 may stop an operation of the sterilization device 81 based on a start of clothes care process of the clothes care apparatus 1 during the operation of the sterilization device 81. Stopping the operation of the sterilization device 81 may include completely stopping the operation of the sterilization device 81.

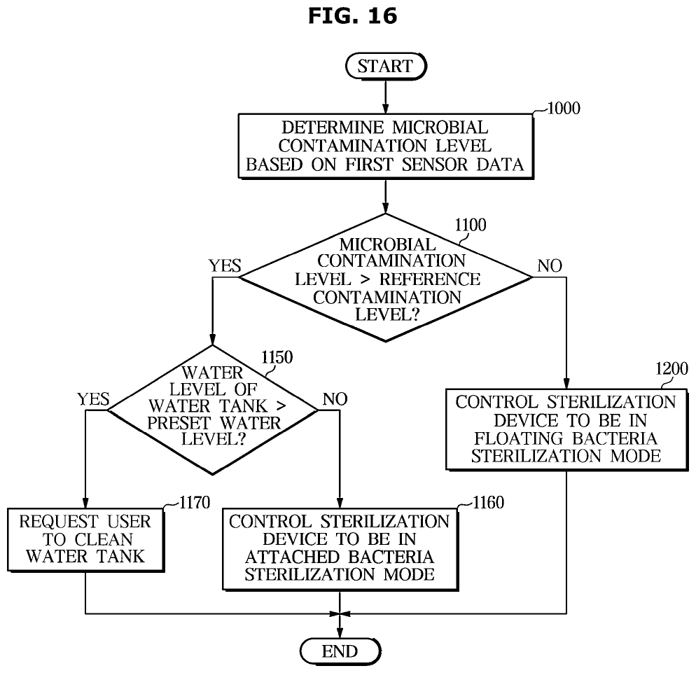

FIG. 16 is a flowchart illustrating an example method for controlling a clothes care apparatus according to various embodiments.

According to various embodiments, the clothes care apparatus 1 may perform the operation of controlling the sterilization device 81 illustrated in FIG. 16, based on completion of a clothes care process (e.g., steam process) or a clothes course. However, a timing at which the clothes care apparatus 1 performs the operation of controlling the sterilization device 81 illustrated in FIG. 16 is not limited thereto. For example, the clothes care apparatus 1 may periodically perform the operation of controlling the sterilization device 81 illustrated in FIG. 16. As another example, the clothes care apparatus 1 may perform the operation of controlling the sterilization device 81 illustrated in FIG. 16, based on completion of operation of the sump pump 115. As still another example, the clothes care apparatus 1 may perform the operation of controlling the sterilization device 81 illustrated in FIG. 16, based on completion of operation of the circulation pump 120. As yet another example, the clothes care apparatus 1 may perform the operation of controlling the sterilization device 81 illustrated in FIG. 16, based on a start of operation of the sump pump 115. As a further example, the clothes care apparatus 1 may perform the operation of controlling the sterilization device 81 illustrated in FIG. 16, based on a start of operation of the circulation pump 120.

Referring to FIG. 16, the clothes care apparatus 1 according to an embodiment may determine a microbial contamination level based on sensor data (hereinafter, “first sensor data”) collected from the microbial detection sensor 85 (1000).

In an embodiment, the controller 250 may determine the microbial contamination level based on the first sensor data. For example, in a case where the microbial detection sensor 85 includes the light receiver 83b, the controller 250 may identify a microbial contamination level corresponding to the amount of light received by the light receiver 83b based on a lookup table pre-stored in the memory 252. As another example, in a case where the microbial detection sensor 85 includes the resistance sensor 84b, the controller 250 may identify a microbial contamination level corresponding to a resistance value between the electrode sensors 84a measured by the resistance sensor 84b based on a lookup table pre-stored in the memory 252.

In an embodiment, the clothes care apparatus 1 may notify a user of the microbial contamination level. For example, the controller 250 may control the output interface device 202 to output information about the microbial contamination level. As another example, the controller 250 may control the communication circuitry 300 to transmit information about the microbial contamination level to an external device.

According to the disclosure, because the user may check the information about the microbial contamination level in the water tank 80, the user's reliability on the contamination level of the water tank 80 may be secured.

The clothes care apparatus 1 may compare the microbial contamination level with a reference contamination level (1100).

Comparing the microbial contamination level with the reference contamination level may include comparing the microbial contamination level, determined based on the first sensor data, with the reference contamination level.

Comparing the microbial contamination level determined based on the first sensor data with the reference contamination level may include comparing a microbial contamination level value determined based on the first sensor data with a reference contamination level value, comparing a light quantity value of light received by the light receiver 83b with a preset light quantity value, and/or comparing the resistance value between the electrode sensors 84a measured by the resistance sensor 84b with a preset resistance value.

The controller 250 may determine an operation mode of the sterilization device 81 based on the comparison of the microbial contamination level determined based on the first sensor data with the reference contamination level.

The operation mode of the sterilization device 81 may include a floating bacteria sterilization mode for sterilizing bacteria floating in the water tank 80, and an attached bacteria sterilization mode for sterilizing bacteria attached to the water tank 80.

Considering that sterilization of floating bacteria in the water tank 80 may be easy, while sterilization of attached bacteria attached to the water tank 80 may not be easy, an operation time of the sterilization device 81 in the attached bacteria sterilization mode requires to be slightly longer than that of the sterilization device 81 in the floating bacteria sterilization mode.

The clothes care apparatus 1 may control the sterilization device 81 to be in the floating bacteria sterilization mode (1200), in a case where the microbial contamination level determined based on the first sensor data is less than the reference contamination level (NO in operation 1100).

In an embodiment, the controller 250 may control the sterilization device 81 based on a first function (1200), in a case where the microbial contamination level determined based on the first sensor data is less than the reference contamination level (NO in operation 1100).

The first function may be configured to output an operation time of the sterilization device 81 using sensor data (hereinafter, “second sensor data”) related to a water level of the water tank 80 collected from the water level sensor 82 as input data.

For example, the first function may include a first lookup table mapping an operation time of the sterilization device 81 to a water level of the water tank 80. For example, the first function may be configured to determine the operation time of the sterilization device 81 based on the first sensor data.

In a case where the microbial contamination level determined based on the first sensor data is greater than or equal to the reference contamination level (Yes in operation 1100), the clothes care apparatus 1 may control the sterilization device 81 to be in the attached bacteria sterilization mode (1160).

For example, the clothes care apparatus 1 may control the sterilization device 81 to be in the attached bacteria sterilization mode (1160), based on the microbial contamination level being greater than or equal to the reference contamination level (Yes in operation 1100) and the water level of the water tank 80 being less than or equal to a preset (defined) water level (NO in operation 1150).

In an embodiment, the controller 250 may control the sterilization device 81 based on a second function (1160), in a case where the microbial contamination level is greater than or equal to the reference contamination level (Yes in operation 1100).

The second function may be configured to output the operation time of the sterilization device 81 using the second sensor data as input data. For example, the second function may be configured to determine the operation time of the sterilization device 81 based on the second sensor data.

For example, the second function may include a second lookup table mapping an operation time of the sterilization device 81 to a water level of the water tank 80.

The first function used in the floating bacteria sterilization mode may be different from the second function used in the attached bacteria sterilization mode.

In an embodiment, a maximum operation time of the sterilization device 81 determinable by the first function may be shorter than a minimum operation time of the sterilization device 81 determinable by the second function.

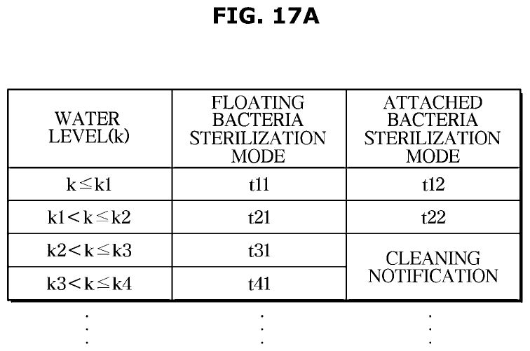

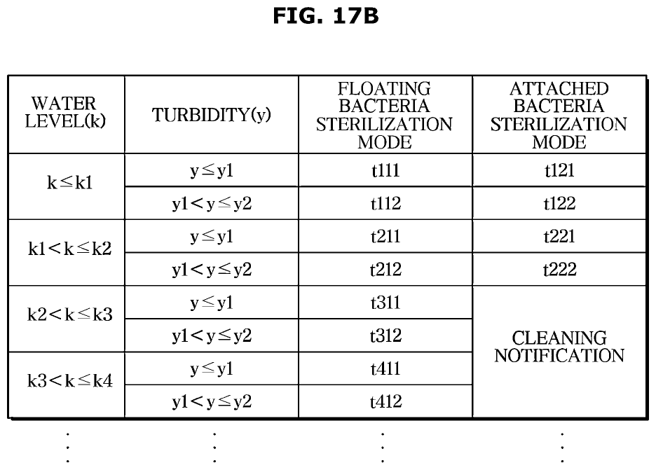

FIG. 17A and FIG. 17B illustrate example lookup tables related to a floating bacteria sterilization mode and an attached bacteria sterilization mode according to various embodiments.

Referring to FIG. 17A, an example of a first lookup table corresponding to the first function used in the floating bacteria sterilization mode and an example of a second lookup table corresponding to the second function used in the attached bacteria sterilization mode may be confirmed.

The memory 252 may store the first lookup table corresponding to the first function and the second lookup table corresponding to the second function.

The first function and/or the second function may output an operation time of the sterilization device 81 using the second sensor data as input data.

For example, according to the first function, in a case where a water level k of the water tank 80 less than or equal to a first reference water level k1 is input, a first time t11 may be output. According to the first function, in a case where a water level k of the water tank 80 greater than the first reference water level k1 and less than or equal to a second reference water level k2 is input, a second time t21 may be output. According to the first function, in a case where a water level k of the water tank 80 greater than the second reference water level k2 and less than or equal to a third reference water level k3 is input, a third time t31 may be output. According to the first function, in a case where a water level k of the water tank 80 greater than the third reference water level k3 and less than or equal to a fourth reference water level k4 is input, a fourth time t41 may be output.

In this instance, the first time t11 may be shorter than the second time t21, the second time t21 may be shorter than the third time t31, and the third time t31 may be shorter than the fourth time t41.

As another example, according to the second function, in a case where a water level k of the water tank 80 less than or equal to the first reference water level k1 is input, a fifth time t12 may be output. According to the second function, in a case where a water level k of the water tank 80 greater than the first reference water level k1 and less than or equal to the second reference water level k2 is input, a sixth time t22 may be output. According to the second function, in a case where a water level k of the water tank 80 greater than the second reference water level k2 is input, instructions for a cleaning notification may be output instead of outputting an operation time of the sterilization device 81.

In this case, the fifth time t12 may be shorter than the sixth time t22.

In an embodiment, the fifth time t22 may be longer than the fourth time t41. For example, the fourth time t41 may be shorter than the fifth time t12. For example, the fourth time t41 may be approximately 50 minutes, and the fifth time t12 may be approximately 150 minutes.

For example, a maximum operation time t41 of the sterilization device 81 determinable by the first function may be shorter than a minimum operation time t12 of the sterilization device 81 determinable by the second function.

The first time t11, the second time t12, the third time t13, the fourth time t14, the fifth time t21, and the sixth time t22 may be defined in advance by factors such as a size and structure of the water tank 80, a performance of the sterilization device 81, and the like, and may be defined so as to satisfy the relationship described above.

The controller 250 may operate the sterilization device 81 during the operation time of the sterilization device 81 determined by the first function or the second function.

In an embodiment, the clothes care apparatus 1 may use sensor data other than the second sensor data to control the sterilization device 81 more efficiently.

For example, the clothes care apparatus 1 may control the sterilization device 81 based on sensor data (hereinafter, “third sensor data”) related to a water quality of the water stored in the water tank 80 collected by the water quality sensor 86.

Referring to FIG. 17B, an example of a first lookup table corresponding to the first function used in the floating bacteria sterilization mode and an example of a second lookup table corresponding to the second function used in the attached bacteria sterilization mode may be confirmed.

The memory 252 may store the first lookup table corresponding to the first function and the second lookup table corresponding to the second function.

The first function and/or the second function may output an operation time of the sterilization device 81 using the second sensor data and the third sensor data as input data.

For example, a water quality of the water stored in the water tank 80 may represent a Nephelometry Turbidity Unit (NTU) of the water stored in the water tank 80, but any value that may quantify the water quality may be used as the third sensor data without limitation.

According to the first function, in a case where a water level k of the water tank 80 less than or equal to a first reference water level k1 is input and a turbidity value y of the water (water stored in the water tank 80) less than or equal to a first reference turbidity y1 is input, a first time t111 may be output. According to the first function, in a case where a water level k of the water tank 80 less than or equal to the first reference water level k1 is input and a turbidity value y of the water (water stored in the water tank 80) greater than the first reference turbidity y1 and less than a second reference turbidity y2 is input, a second time t112 may be output. According to the first function, in a case where a water level k of the water tank 80 greater than the first reference water level k1 and less than or equal to a second reference water level k2 is input and a turbidity value y of the water (water stored in the water tank 80) less than or equal to the first reference turbidity y1 is input, a third time t211 may be output. According to the first function, in a case where a water level k of the water tank 80 greater than the first reference water level k1 and less than or equal to the second reference water level k2 is input and a turbidity value y of the water (water stored in the water tank 80) greater than the first reference turbidity y1 and less than or equal to the second reference turbidity y2 is input, a fourth time t212 may be output. According to the first function, in a case where a water level k of the water tank 80 greater than the second reference water level k2 and less than or equal to a third reference water level k3 is input and a turbidity value y of the water (water stored in the water tank 80) less than or equal to the first reference turbidity y1 is input, a fifth time t311 may be output. According to the first function, in a case where a water level k of the water tank 80 greater than the second reference water level k2 and less than or equal to the third reference water level k3 is input and a turbidity value y of the water (water stored in the water tank 80) greater than the first reference turbidity y1 and less than or equal to the second reference turbidity y2 is input, a sixth time t312 may be output. According to the first function, in a case where a water level k of the water tank 80 greater than the third reference water level k3 and less than or equal to a fourth reference water level k4 is input and a turbidity value y of the water (water stored in the water tank 80) less than or equal to the first reference turbidity y1 is input, a seventh time t411 may be output. According to the first function, in a case where a water level k of the water tank 80 greater than the third reference water level k3 and less than or equal to the fourth reference water level k4 is input and a turbidity value y of the water (water stored in the water tank 80) greater than the first reference turbidity y1 and less than or equal to the second reference turbidity y2 is input, an eighth time t412 may be output.

In this instance, the first time t111 may be shorter than the second time t112, the third time t211 may be shorter than the fourth time t212, the fifth time t311 may be shorter than the sixth time t312, and the seventh time t411 may be shorter than the eighth time t412.

In addition, the first time t111 may be shorter than the third time t211, the third time t211 may be shorter than the fifth time t311, and the fifth time t311 may be shorter than the seventh time t411.

In addition, the second time t112 may be shorter than the fourth time t212, the fourth time t212 may be shorter than the sixth time t312, and the sixth time t312 may be shorter than the eighth time t412.

In addition, the second time t112 may be similar to the third time t211, the fourth time t212 may be similar to the fifth time t311, and the sixth time t312 may be similar to the seventh time t411.

As another example, according to the second function, in a case where a water level k of the water tank 80 less than or equal to the first reference water level k1 is input and a turbidity value y of the water (water stored in the water tank 80) less than or equal to the first reference turbidity y1 is input, a ninth time t121 may be output. According to the second function, in a case where a water level k of the water tank 80 less than or equal to the first reference water level k1 is input and a turbidity value y of the water (water stored in the water tank 80) greater than the first reference turbidity y1 and less than the second reference turbidity y2 is input, a tenth time t122 may be output. According to the second function, in a case where a water level k of the water tank 80 greater than the first reference water level k1 and less than or equal to the second reference water level k2 is input and a turbidity value y of the water (water stored in the water tank 80) less than or equal to the first reference turbidity y1 is input, an eleventh time t221 may be output. According to the second function, in a case where a water level k of the water tank 80 greater than the first reference water level k1 and less than or equal to the second reference water level k2 is input and a turbidity value y of the water (water stored in the water tank 80) greater than the first reference turbidity y 1 and less than or equal to the second reference turbidity y2 is input, a twelfth time t222 may be output.

According to the second function, in a case where a water level k of the water tank 80 greater than the second reference water level k2 is input, instructions for a cleaning notification may be output instead of outputting an operation time of the sterilization device 81.

In an embodiment, the ninth time t121 may be longer than the eighth time t412. For example, the eighth time t412 may be shorter than the ninth time t121. For example, the eighth time t412 may be approximately 50 minutes, and the ninth time t121 may be approximately 150 minutes.

For example, a maximum operation time t412 of the sterilization device 81 determinable by the first function may be shorter than a minimum operation time t121 of the sterilization device 81 determinable by the second function.

The controller 250 may operate the sterilization device 81 during the operation time of the sterilization device 81 determined by the first function or the second function.

According to the disclosure, floating bacteria or attached bacteria in the water tank 80 may be efficiently removed by varying an emission time of the sterilization device 81 depending on a microbial contamination level.

The lookup tables of FIG. 17A and FIG. 17B are merely examples, and the disclosure is not limited thereto.

For example, the controller 250 may control the sterilization device 81 using a function and/or a trained artificial intelligence (AI) model that outputs an operation time of the sterilization device 81 based on the input of a microbial contamination level and a water level of the water tank 80. For example, the controller 250 may control the sterilization device 81 using the function and/or trained AI model that outputs an operation time of the sterilization device 81 using the first sensor data and the second sensor data as input data.

In the function and/or trained AI model that outputs an operation time of the sterilization device 81 based on the input of the microbial contamination level and the water level of the water tank 80, a weight assigned to the microbial contamination level may be greater than a weight assigned to the water level of the water tank 80.

As another example, the controller 250 may control the sterilization device 81 using a function and/or trained AI model that outputs an operation time of the sterilization device 81 based on the input of a microbial contamination level, a water level of the water tank 80, and a water quality of the water stored in the water tank 80. For example, the controller 250 may control the sterilization device 81 using the function and/or trained AI model that outputs an operation time of the sterilization device 81 using the first sensor data, the second sensor data, and the third sensor data as input data.

In the function and/or trained AI model that outputs an operation time of the sterilization device 81 based on the input of the microbial contamination level, the water level of the water tank 80, and the water quality of the water stored in the water tank 80, a weight assigned to the microbial contamination level may be greater than a weight assigned to the water level of the water tank 80.

In the function and/or trained AI model that outputs an operation time of the sterilization device 81 based on the input of the microbial contamination level, the water level of the water tank 80, and the water quality of the water stored in the water tank 80, a weight assigned to the water level of the water tank 80 may be greater than a weight assigned to the water quality of the water stored in the water tank 80.

According to the disclosure, the operation time of the sterilization device 81 may be varied depending on the presence or absence of microorganisms attached to the water tank 80, and thus the clothes care apparatus 1 and a method for controlling the clothes care apparatus 1 may optimally control the sterilization device 81.

Referring back to FIG. 16, the clothes care apparatus 1 may request a user to clean the water tank 80 (1170), based on the microbial contamination level being greater than or equal to the reference contamination level (Yes in operation 1100) and the water level of the water tank 80 being greater than the preset water level (k2 of FIG. 17A and FIG. 17B) (Yes in operation 1150).

The operation of requesting the user to clean the water tank 80 may be performed without operating the sterilization device 81. For example, the clothes care apparatus 1 may not operate the sterilization device 81 based on the microbial contamination level being greater than or equal to the reference contamination level (Yes in operation 1100) and the water level of the water tank 80 being greater than the preset water level (k2 of FIG. 17A and FIG. 17B) (Yes in operation 1150).

In an embodiment, the controller 250 may control the output interface device 202 to notify that cleaning of the water tank 80 is required based on the microbial contamination level being greater than or equal to the reference contamination level and the water level of the water tank 80 being greater than the preset water level.

Controlling the output interface device 202 to notify that cleaning of the water tank 80 is required may include outputting a visual indicator indicating that cleaning of the water tank 80 is required. Furthermore, controlling the output interface device 202 to notify that cleaning of the water tank 80 is required may include outputting other sensory information (e.g., auditory information, tactile information, etc.) indicating that cleaning of the water tank 80 is required.

In an embodiment, the controller 250 may control the communication unit to notify an external device that cleaning of the water tank 80 is required based on the microbial contamination level being greater than or equal to the reference contamination level and the water level of the water tank 80 being greater than the preset water level.

Controlling the communication unit to notify the external device that cleaning of the water tank 80 is required may include transmitting information about the microbial contamination level to the external device, transmitting a signal indicating that the microbial contamination level is greater than or equal to the reference contamination level to the external device, and/or transmitting a signal indicating that cleaning of the water tank 80 is required to the external device.

According to the disclosure, in a case where sterilization of the attached bacteria may not be performed due to attached bacteria formed in the water tank 80 and a high water level of the water tank 80, the clothes care apparatus 1 may cause the user to clean the water tank 80.

The method for controlling the clothes care apparatus 1 according to an embodiment may further include other operations in addition to the operations illustrated in FIG. 16, and may not include some of the operations illustrated in FIG. 16.

In an embodiment, the clothes care apparatus 1 may notify the user of the microbial contamination level based on the determination of the microbial contamination level.

In an embodiment, the clothes care apparatus 1 may stop the operation of the sterilization device 81 based on the water tank 80 being withdrawn from the main body 10 while the sterilization device 81 is operating according to operation 1160 or 1200. The water tank 80 withdrawn from the main body 10 may be detected by the mounting detection sensor.

According to an embodiment of the disclosure, the user may be prevented and/or avoided from being exposed to ultraviolet rays.

In an embodiment, the clothes care apparatus 1 may stop the operation of the sterilization device 81 based on a start of a clothes care process while the sterilization device 81 is operating according to operation 1160 or 1200.

The start of the clothes care process may include an actual start of the clothes care process or receipt of user input to start the clothes care process.

According to an embodiment of the disclosure, power waste caused by unnecessary operation of the sterilization device 81 may be prevented and/or avoided.

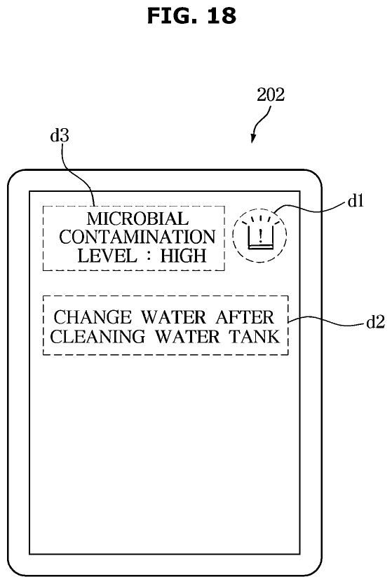

FIG. 18 is a diagram illustrating an example interface provided by a clothes care apparatus, in a case where cleaning of a water tank is required according to various embodiments.

Referring to FIG. 18, the controller 250 may control the output interface device 202 to output visual indicators d1 and d2 for requesting cleaning of the water tank 80 based on a microbial contamination level being greater than or equal to the reference contamination level and a water level of the water tank 80 being greater than the preset water level.

The visual indicators d1 and d2 for requesting cleaning of the water tank 80 may include the icon d1 for requesting cleaning of the water tank 80 and/or the text d2 for requesting cleaning of the water tank 80. However, the types of visual indicators d1 and d2 for requesting cleaning of the water tank 80 are not limited thereto, and the visual indicators d1 and d2 for requesting cleaning of the water tank 80 may be output by the output interface device 202 in various manners (e.g., animation, text, figure, etc.).

In an embodiment, the controller 250 may control the output interface device 202 to output information about the microbial contamination level based on the determination of the microbial contamination level.

For example, the controller 250 may control the output interface device 202 to output a visual indicator d3 indicating information about the microbial contamination level.

The visual indicator d3 indicating information about the microbial contamination level may include text, phrase, figure, animation, and/or icon indicating the microbial contamination level. The visual indicator d3 indicating information about the microbial contamination level may either indicate the microbial contamination level numerically or indicate the microbial contamination level in comparative words (e.g., low, medium, high, etc.).

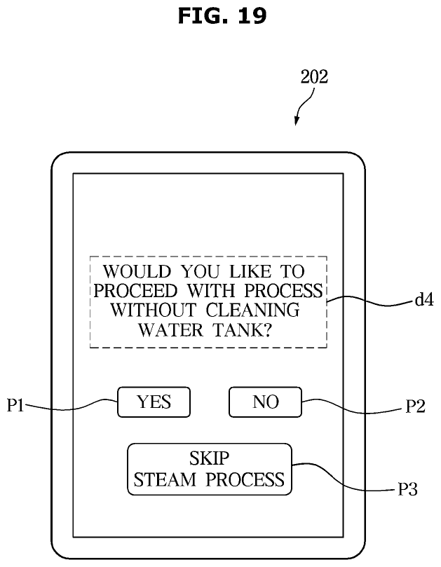

FIG. 19 is a diagram illustrating an example interface provided by a clothes care apparatus, in a case where a user input to start a clothes care process is received in a state where cleaning of a water tank is required according to various embodiments.

A user who receives a request to clean the water tank 80 from the clothes care apparatus 1 may clean the water tank 80, refill water, and then remount the water tank 80 to the main body 10.

However, the user may intentionally or unintentionally ignore the request to clean the water tank 80 and proceed with a clothes care process.

In an embodiment, the clothes care apparatus 1 may confirm that the cleaning of the water tank 80 has been performed in response to a preset condition being satisfied after operation 1170.

For example, the controller 250 may determine that the cleaning of the water tank 80 is completed based on receiving a user input indicating that the cleaning of the water tank 80 is completed through the input interface device 201 after operation 1170.

As another example, in a case where withdrawal and mounting of the water tank 80 is detected after operation 1170, the controller 250 may redetermine a microbial contamination level based on the first sensor data. The controller 250 may determine that the cleaning of the water tank 80 is completed based on the redetermined microbial contamination level being less than the reference contamination level. Conversely, the controller 250 may determine that the cleaning of the water tank 80 is not performed based on the redetermined microbial contamination level being greater than or equal to the reference contamination level.

As still another example, the controller 250 may redetermine the microbial contamination level based on the first sensor data, in a case where a user input to start the clothes care process is received after operation 1170. The controller 250 may determine that the cleaning of the water tank 80 is completed based on the redetermined microbial contamination level being less than the reference contamination level. Conversely, the controller 250 may determine that the cleaning of the water tank 80 is not performed based on the redetermined microbial contamination level being greater than or equal to the reference contamination level.

In an embodiment, in a case where the clothes care apparatus 1 receives a user input to start the clothes care process through the input interface device 201 or the communication circuitry 300 after operation 1170 and it is determined that the cleaning of the water tank 80 is not performed, the clothes care apparatus 1 may provide feedback for asking a user intent.

In an embodiment, in a case where a user input to start the clothes care process is received through the input interface device 201 or the communication circuitry 300 and it is determined that the cleaning of the water tank 80 is not performed, the controller 250 may control the output interface device 202 to output a visual indicator d4 for asking a user intent to proceed with the clothes care process.

The controller 250 may control the output interface device 202 to output the visual indicator d4 for asking the user intent to proceed with the clothes care process in response to a selection of the operation/pause button after a course is selected through the input interface device 201.

The controller 250 may control the output interface device 202 to output user interface elements P1, P2, and P3 for confirming the user intent to proceed with the clothes care process.

The user interface elements P1, P2, and P3 for confirming the user intent to proceed with the clothes care process may include the first element P1 for confirming a positive intent, the second element P2 for confirming a negative intent, and/or a third element P3 for proceeding only with a process that does not use water stored in the water tank 80.

The controller 250 may control the clothes care apparatus 1 to proceed with the clothes care process based on the selection of the first element P1.

Based on the selection of the second element P2, the controller 250 may control the output interface device 202 to output an initial screen or a guide screen guiding a cleaning method of the water tank 80 without proceeding with the clothes care process.

Based on the selection of the third element P3, the controller 250 may control the clothes care apparatus 1 to proceed with the clothes care process excluding a steam process. For example, the controller 250 may not operate the steam generation device 70 during the clothes care process based on the selection of the third element P3.

According to the disclosure, in a case where the water in the water tank 80 is contaminated, the clothes care apparatus 1 and the method for controlling the clothes care apparatus 1 may perform subsequent operations by reflecting a user intent.

According to the disclosure, in a case where the water in the water tank 80 is contaminated, the clothes care apparatus 1 and the method for controlling the clothes care apparatus 1 may perform a clothes care process excluding a steam process, thereby preventing or avoiding contamination of clothes.

The disclosure is also applicable to other appliances (or electronic devices) other than the clothes care apparatus 1. In other words, the disclosed embodiments may be applied to a variety of appliances that may include the steam generation device 70.

According to various embodiments, a variety of appliances, such as a washing machine, dryer, shoe care apparatus, cooking appliance (e.g., steam oven), dishwasher, cleaner, steam iron, air conditioner, and/or humidifier, may include the steam generation device 70, the sterilization device 81, and the controller 250 for controlling the steam generation device 70 and the sterilization device 81 according to an embodiment. According to various embodiments, various appliances, such as a washing machine, dryer, shoe care apparatus, cooking appliance (e.g., steam oven), dishwasher, cleaner, steam iron, air conditioner, and/or humidifier, may not include some components (e.g., sump 105) of the steam generation system 100 according to an embodiment.

A variety of appliances, such as a washing machine, dryer, shoe care apparatus, cooking appliance (e.g., steam oven), dishwasher, cleaner, steam iron, air conditioner, steam sterilizer, steam hairstyling device, and/or humidifier, may control the sterilization device 81 and the user interface device according to the above-described embodiments.

The washing machine according to an embodiment may include the steam generation device 70, the sterilization device 81, and the controller 250, and may use steam for washing a garment to improve a washing effectiveness.

The dryer according to an embodiment may include the steam generation device 70, the sterilization device 81, and the controller 250, and may use steam for drying a garment to sterilize an object to be dried.

The shoe care apparatus according to an embodiment may include the steam generation device 70, the sterilization device 81, and the controller 250, and may use steam for drying shoes to sterilize the shoes.

The steam oven according to an embodiment may include the steam generation device 70, the sterilization device 81, and the controller 250, and may use steam for cooking food to maintain moisture in the food.

The dishwasher according to an embodiment may include the steam generation device 70, the sterilization device 81, and the controller 250, and may use steam to efficiently remove residues left on dishes.

The cleaner according to an embodiment may include the steam generation device 70, the sterilization device 81, and the controller 250, and may use steam to efficiently clean an area to be cleaned.

The steam iron according to an embodiment may include the steam generation device 70, the sterilization device 81, and the controller 250, and may use steam to improve ironing performance.

The air conditioner according to an embodiment may include the steam generation device 70, the sterilization device 81, and the controller 250, and may use steam to adjust humidity and improve air quality.

The steam sterilizer according to an embodiment may include the steam generation device 70, the sterilization device 81, and the controller 250, and may spray steam to an object to be sterilized to sterilize the object to be sterilized.

The steam hairstyling device according to an embodiment may include the steam generation device 70, the sterilization device 81, and the controller 250, and may spray steam to a user's hair to assist in styling the user's hair.

The humidifier according to an embodiment may include the steam generation device 70, the sterilization device 81, and the controller 250, and may use steam to adjust humidity and improve air quality.

According to an example embodiment of the disclosure, a clothes care apparatus may include: a steam generation device comprising a steam generator; a water tank configured to supply water to the steam generation device, and recover the water discharged from the steam generation device; a microbial detection sensor configured to collect first sensor data related to an amount of microorganisms attached to the water tank; a water level 82 configured to collect second sensor data related to a water level of the water tank; a sterilization device comprising circuitry configured to sterilize water stored in the water tank; and a controller including at least one processor, individually and/or collectively, configured to: control the sterilization device based on a first function related to the second sensor data, in response to a microbial contamination level determined based on the first sensor data being less than a reference contamination level, and control the sterilization device based on a second function related to the second sensor data, in response to the microbial contamination level being greater than or equal to the reference contamination level, wherein the first function and the second function may be configured to determine an operation time of the sterilization device based on the second sensor data, and a maximum operation time of the sterilization device determinable by the first unction may be shorter than a minimum operation time of the sterilization device determinable by the second function.

In an example embodiment, the clothes care apparatus may further include a water quality sensor configured to collect third sensor data related to a water quality of the water stored in the water tank, wherein the first function and the second function are configured to determine the operation time of the sterilization device based on the second sensor data and the third sensor data.

In an example embodiment, the clothes care apparatus may further include an output interface device comprising circuitry, wherein at least one processor, individually and/or collectively, may be configured to control the output interface device to notify that cleaning of the water tank is required, based on the microbial contamination level being greater than or equal to the reference contamination level and the water level of the water tank being greater than a defined water level.

In an example embodiment, the clothes care apparatus may further include communication circuitry configured to communicate with an external device, wherein at least one processor, individually and/or collectively, may be configured to control the communication circuitry to notify the external device that cleaning of the water tank is required, based on the microbial contamination level being greater than or equal to the reference contamination level and the water level of the water tank being greater than a defined water level.

In an example embodiment, at least one processor, individually and/or collectively, may be configured to not operate the sterilization device based on the microbial contamination level being greater than or equal to the reference contamination level and the water level of the water tank being greater than a defined water level.

In an example embodiment, the clothes care apparatus may further include: a water purification filter disposed upstream of the water tank; a water supply pump configured to pump water from the water tank to the steam generation device; and a circulation pump configured to pump water discharged from the steam generation device to the water purification filter.

In an example embodiment, at least one processor, individually and/or collectively, may be configured to control the output interface device to output information about the microbial contamination level.

In an example embodiment, at least one processor, individually and/or collectively, may be configured to control the clothes care apparatus to perform a clothes care process, and perform an operation to control the sterilization device based on completion of the clothes care process. In an example embodiment, the water tank may include a bottom side with a transparent area, and the microbial detection sensor may include a light emitter configured to emit light toward the bottom side of the water tank and a light receiver disposed below the transparent area.

In an example embodiment, the sterilization device may include an ultraviolet (UV) emitter configured to emit ultraviolet rays, the water tank may include a bottom side with a transparent area, and the microbial detection sensor may include a light receiver disposed below the transparent area.

In an example embodiment, the microbial detection sensor may include a pair of electrode sensors arranged on a bottom side of the water tank.

In an example embodiment, at least one processor, individually and/or collectively, may be configured to operate the sterilization device for the operation time of the sterilization device determined by the first function or the second function.

In an example embodiment, the water tank may be configured to be detachable from a main body of the clothes care apparatus, and at least one processor, individually and/or collectively, may be configured to stop an operation of the sterilization device based on the water tank being withdrawn from the main body during the operation of the sterilization device.

In an example embodiment, at least one processor, individually and/or collectively, may be configured to stop an operation of the sterilization device based on a start of a clothes care process of the clothes care apparatus during operation of the sterilization device.

According to an example embodiment of the disclosure, in a method for controlling a clothes care apparatus including a steam generation device comprising a steam generator, a water tank configured to supply water to the steam generation device and recover the water discharged from the steam generation device, and a sterilization device comprising circuitry configured to sterilize water stored in the water tank, the method may include: receiving first sensor data, related to an amount of microorganisms attached to the water tank, from a microbial detection sensor configured to collect the first sensor data; receiving second sensor data, related to a water level of the water tank, from a water level sensor configured to collect the second sensor data; controlling the sterilization device based on a first function related to the second sensor data, in response to a microbial contamination level determined based on the first sensor data being less than a reference contamination level; and controlling the sterilization device based on a second function related to the second sensor data, in response to the microbial contamination level being greater than or equal to the reference contamination level, wherein the first function and the second function may be configured to determine an operation time of the sterilization device based on the second sensor data, and a maximum operation time of the sterilization device determinable by the first unction may be shorter than a minimum operation time of the sterilization device determinable by the second function.

In an example embodiment, the method may further include receiving third sensor data, related to a water quality of the water stored in the water tank, from a water quality sensor configured to collect the third sensor data, wherein the first function and the second function may be configured to determine the operation time of the sterilization device based on the second sensor data and the third sensor data.

In an example embodiment, the method may further include notifying that cleaning of the water tank is required based on the microbial contamination level being greater than or equal to the reference contamination level and the water level of the water tank, determined based on the second sensor data, being greater than a defined water level.

In an example embodiment, the method may further include: not operating the sterilization device based on the microbial contamination level being greater than or equal to the reference contamination level and the water level of the water tank, determined based on the second sensor data, being greater than a defined water level.

In an example embodiment, the method may further include outputting information about the microbial contamination level.

In an example embodiment, the method may further include controlling the clothes care apparatus to perform a clothes care process, and the controlling of the sterilization device may be performed based on completion of the clothes care process.

The disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be read only memory (ROM), random access memory (RAM), a magnetic tape, a magnetic disc, a flash memory, an optical data storage device, etc.

The computer-readable recording medium may be provided in the form of a non-transitory storage medium, wherein the ‘non-transitory storage medium’ is a storage medium that is a tangible device, and may not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

According to an embodiment, the method according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a storage medium, such as a memory of a server of a manufacturer, a server of an application store, or a relay server.

Although various example embodiments of the disclosure have been described with reference to the accompanying drawings, it will be understood that the various embodiments are intended to be illustrative, not limiting. It will be further understood that one of ordinary skill in the art will appreciate that other various modifications may be easily made without departing from the technical spirit or essential features of the disclosure. Therefore, the foregoing embodiments should be regarded as illustrative rather than limiting in all aspects. It will also be understood that any of the embodiment(s) described herein may be used in conjunction with any other embodiment(s) described herein.

What is claimed is:

1. A clothes care apparatus, comprising:
a steam generation device comprising a steam generator;
a water tank configured to supply water to the steam generation device, and recover the water discharged from the steam generation device;
a microbial detection sensor configured to collect first sensor data related to an amount of microorganisms attached to the water tank;
a water level sensor configured to collect second sensor data related to a water level of the water tank;
a sterilization device comprising circuitry configured to sterilize water stored in the water tank; and
a controller comprising at least one processor, comprising processing circuitry, individually and/or collectively, configured to control the sterilization device based on a first function related to the second sensor data, in response to a microbial contamination level determined based on the first sensor data being less than a reference contamination level, and control the sterilization device based on a second function related to the second sensor data, in response to the microbial contamination level being greater than or equal to the reference contamination level,
wherein the first function and the second function are configured to determine an operation time of the sterilization device based on the second sensor data, and
a maximum operation time of the sterilization device determinable by the first unction is shorter than a minimum operation time of the sterilization device determinable by the second function.

2. The clothes care apparatus of claim 1, further comprising:
a water quality sensor configured to collect third sensor data related to a water quality of the water stored in the water tank,
wherein the first function and the second function are configured to determine the operation time of the sterilization device based on the second sensor data and the third sensor data.

3. The clothes care apparatus of claim 1, further comprising:
an output interface device comprising circuitry,
wherein at least one processor, individually and/or collectively, is configured to: control the output interface device to notify that cleaning of the water tank is required, based on the microbial contamination level being greater than or equal to the reference contamination level and the water level of the water tank being greater than a defined water level.

4. The clothes care apparatus of claim 1, further comprising:
communication circuitry configured to communicate with an external device,
wherein at least one processor, individually and/or collectively, is configured to control the communication circuitry to notify the external device that cleaning of the water tank is required, based on the microbial contamination level being greater than or equal to the reference contamination level and the water level of the water tank being greater than a defined water level.

5. The clothes care apparatus of claim 1, wherein at least one processor, individually and/or collectively, is configured to not operate the sterilization device based on the microbial contamination level being greater than or equal to the reference contamination level and the water level of the water tank being greater than a defined water level.

6. The clothes care apparatus of claim 1, further comprising:
a water purification filter disposed upstream of the water tank;
a water supply pump configured to pump water from the water tank to the steam generation device; and
a circulation pump configured to pump water discharged from the steam generation device to the water purification filter.

7. The clothes care apparatus of claim 1, further comprising:
an output interface device comprising circuitry,
wherein at least one processor, individually and/or collectively, is configured to control the output interface device to output information about the microbial contamination level.

8. The clothes care apparatus of claim 1, wherein at least one processor, individually and/or collectively, is configured to control the clothes care apparatus to: perform a clothes care process, and perform an operation to control the sterilization device based on completion of the clothes care process.

9. The clothes care apparatus of claim 1, wherein the water tank comprises a bottom side with a transparent area, and
the microbial detection sensor comprises a light emitter configured to emit light toward the bottom side of the water tank and a light receiver disposed below the transparent area.

10. The clothes care apparatus of claim 1, wherein the sterilization device comprises an ultraviolet (UV) emitter configured to emit ultraviolet rays,
the water tank comprises a bottom side including a transparent area, and
the microbial detection sensor comprises a light receiver disposed below the transparent area.

11. The clothes care apparatus of claim 1, wherein the microbial detection sensor comprises a pair of electrode sensors arranged on a bottom side of the water tank.

12. The clothes care apparatus of claim 1, wherein at least one processor, individually and/or collectively, is configured to operate the sterilization device for the operation time of the sterilization device determined by the first function or the second function.

13. The clothes care apparatus of claim 1, wherein the water tank is configured to be detachable from a main body of the clothes care apparatus, and
at least one processor, individually and/or collectively, is configured to stop an operation of the sterilization device based on the water tank being withdrawn from the main body during the operation of the sterilization device.

14. The clothes care apparatus of claim 1, wherein at least one processor, individually and/or collectively, is configured to stop an operation of the sterilization device based on a start of a clothes care process of the clothes care apparatus during the operation of the sterilization device.

15. A method for controlling a clothes care apparatus comprising a steam generation device including a steam generator, a water tank configured to supply water to the steam generation device and recover the water discharged from the steam generation device, and a sterilization device comprising circuitry configured to sterilize water stored in the water tank, the method comprising:
receiving first sensor data, related to an amount of microorganisms attached to the water tank, from a microbial detection sensor configured to collect the first sensor data;
receiving second sensor data, related to a water level of the water tank, from a water level sensor configured to collect the second sensor data;
controlling the sterilization device based on a first function related to the second sensor data, in response to a microbial contamination level determined based on the first sensor data being less than a reference contamination level; and
controlling the sterilization device based on a second function related to the second sensor data, in response to the microbial contamination level being greater than or equal to the reference contamination level,
wherein the first function and the second function are configured to determine an operation time of the sterilization device based on the second sensor data, and
a maximum operation time of the sterilization device determinable by the first unction is shorter than a minimum operation time of the sterilization device determinable by the second function.

16. The method of claim 15, further comprising receiving third sensor data, related to a water quality of the water stored in the water tank from a water quality sensor configured to collect the third sensor data, wherein the first function and the second function is configured to determine the operation time of the sterilization device based on the second sensor data and the third sensor data.

17. The method of claim 15, further comprising notifying that cleaning of the water tank is required based on the microbial contamination level being greater than or equal to the reference contamination level and the water level of the water tank, determined based on the second sensor data, being greater than a defined water level.

18. The method of claim 15, further comprising not operating the sterilization device based on the microbial contamination level being greater than or equal to the reference contamination level and the water level of the water tank, determined based on the second sensor data, being greater than a defined water level.

19. The method of claim 15, further comprising outputting information about the microbial contamination level.

20. The method of claim 15, further comprising controlling the clothes care apparatus to perform a clothes care process, wherein the controlling of the sterilization device is performed based on completion of the clothes care process.
